(19) United States
(12) Patent Application Publication
(10) Pub. No.: US 2024/0073704 A1
(43) Pub. Date: Feb. 29, 2024

(54) COMMUNICATION DEVICE, COMMUNICATION SYSTEM, AND COMMUNICATION METHOD

(71) Applicant: NEC Corporation, Minato-ku, Tokyo (JP)

(72) Inventors: Koya TAKATA, Tokyo (JP); Hisashi MIZUMOTO, Tokyo (JP); Atsushi KAMOI, Tokyo (JP)

(73) Assignee: NEC Corporation, Minato-ku, Tokyo (JP)

(21) Appl. No.: 18/274,361

(22) PCT Filed: Mar. 14, 2022
(86) PCT No.: PCT/JP2022/011174

§ 371 Date: Jul. 26, 2023

(30) Foreign Application Priority Data
Mar. 31, 2021 (JP) 2021-061070

(51) Int. Cl. H04W 16/28

(52) U.S. Cl. CPC H04W 16/28

(57) ABSTRACT

A communication apparatus (20) according to an example aspect of the present invention includes: at least one communication means (21) that is configured to be capable of transmitting and receiving directional communication media; and a determination means (22) that determines at least one communication destination with which to communicate by the at least one communication means, in the case of determination of communication with a plurality of communication destinations, the determination means selecting the plurality of communication destinations so that an angle between the plurality of communication destinations as viewed from the communication apparatus is not less than a predetermined angle.

### TECHNICAL FIELD

The present invention relates to a communication apparatus, a communication system, and a communication method each for carrying out communication by a directional communication medium.

### BACKGROUND ART

Communication technologies that make it possible to achieve large capacity and low delay are required in the field of communication networks. As one of such communication technologies, a communication technology is being developed in which a directional communication medium such as millimeter wave or visible light band light is used. For example, Patent Literature 1 discloses a communication system for carrying out multi-hop communication of data with use of a relay apparatus that uses directional millimeter waves to form a subnetwork and a connection terminal that is connected to the subnetwork.

### CITATION LIST

### Patent Literature

[Patent Literature 1]
Japanese Patent Application Publication Tokukai No. 2019-161373

### SUMMARY OF INVENTION

### Technical Problem

A directional communication medium has the following aspects. Specifically, the directional communication medium, which has a large frequency, can be expected to achieve large-capacity and low-delay communication. In contrast, the directional communication medium is susceptible to influence such as shielding and/or disturbance due to its directionality.

In order to ensure robustness of communication while using a directional communication medium, a configuration is preferable that makes it possible to make adaptive changes including node subscription to a network and a change in node position. However, even use of the technique disclosed in Patent Literature 1 is insufficient to achieve such a configuration.

An example aspect of the present invention has been made in view of the above problems, and an example object thereof is to provide a technique for achieving a robust communication network in which a directional communication medium is used.

### Solution to Problem

A communication apparatus according to an example aspect of the present invention includes: at least one communication means that is configured to be capable of transmitting and receiving directional communication media; and a determination means that determines at least one communication destination with which to communicate by the at least one communication means, in the case of determination of communication with a plurality of communication destinations, the determination means selecting the plurality of communication destinations so that an angle between the plurality of communication destinations as viewed from the communication apparatus is not less than a predetermined angle.

A communication apparatus according to an example aspect of the present invention includes: at least one communication means that is configured to be capable of transmitting and receiving directional communication media; and a determination means that determines priority of at least one communication destination with which to communicate by the at least one communication means, in a case where a communication destination candidate is present in a range of predetermined angles from a connected communication destination, the determination means lowering priority of the communication destination candidate.

A communication apparatus according to an example aspect of the present invention includes: at least one communication means that is configured to be capable of transmitting and receiving directional communication media; and a determination means that determines at least one communication destination with which to communicate by the at least one communication means, the determination means determining the at least one communication destination from among at least one communication destination candidate with reference to positional information of the at least one communication destination candidate.

A communication system according to an example aspect of the present invention includes a plurality of communication apparatuses, wherein at least any two or more of the plurality of communication apparatuses each include: at least one communication means that is configured to be capable of transmitting and receiving directional communication media; and a determination means that determines at least one communication destination with which to communicate by the at least one communication means, in the case of determination of communication with a plurality of communication destinations, the determination means selecting the plurality of communication destinations so that an angle between the plurality of communication destinations as viewed from a corresponding communication apparatus is not less than a predetermined angle.

A communication system according to an example aspect of the present invention includes a plurality of communication apparatuses, wherein at least any two or more of the plurality of communication apparatuses each include: at least one communication means that is configured to be capable of transmitting and receiving directional communication media; and a determination means that determines priority of at least one communication destination with which to communicate by the at least one communication means, in a case where a communication destination candidate is present in a range of predetermined angles from a connected communication destination, the determination means lowering priority of the communication destination candidate.

A communication system according to an example aspect of the present invention includes a plurality of communication apparatuses, wherein at least any two or more of the plurality of communication apparatuses each include: at least one communication means that is configured to be capable of transmitting and receiving directional communication media; and a determination means that determines at least one communication destination with which to communicate by the at least one communication means, the determination means determining the at least one communication destination from among at least one communication destination candidate with reference to positional information of the at least one communication destination candidate.

A communication method according to an example aspect of the present invention includes determining at least one communication destination of a communication apparatus including at least one communication means that is configured to be capable of transmitting and receiving directional communication media, wherein in the determining, in the case of determination of communication with a plurality of communication destinations, the plurality of communication destinations are selected so that an angle between the plurality of communication destinations as viewed from the communication apparatus is not less than a predetermined angle.

A communication method according to an example aspect of the present invention includes determining priority of at least one communication destination of a communication apparatus including at least one communication means that is configured to be capable of transmitting and receiving directional communication media, wherein in the determining, in a case where a communication destination candidate is present in a range of predetermined angles from a connected communication destination, priority of the communication destination candidate is lowered.

A communication method according to an example aspect of the present invention includes determining at least one communication destination of a communication apparatus including at least one communication means that is configured to be capable of transmitting and receiving directional communication media, wherein in the determining, the at least one communication destination is determined from among at least one communication destination candidate with reference to positional information of the at least one communication destination candidate.

### Advantageous Effects of Invention

An example aspect of the present invention makes it possible to achieve a robust communication network in which a directional communication medium is used.

### BRIEF DESCRIPTION OF DRAWINGS

FIG. 1 is a block diagram illustrating a configuration of a communication apparatus according to a first example embodiment of the present invention.

FIG. 2 is a flowchart illustrating a flow of a communication method according to the first example embodiment of the present invention.

FIG. 3 is a block diagram illustrating a configuration of a communication system according to the first example embodiment of the present invention.

FIG. 4 is a block diagram illustrating a configuration of a communication apparatus according to a second example embodiment of the present invention.

FIG. 5 is a flowchart illustrating a flow of a communication method according to the second example embodiment of the present invention.

FIG. 6 is a block diagram illustrating a configuration of a communication system according to the second example embodiment of the present invention.

FIG. 7 is a block diagram illustrating a configuration of a communication apparatus according to a third example embodiment of the present invention.

FIG. 8 is a sequence diagram illustrating a first example of a flow of a process from scanning to connection establishment in a communication system according to the third example embodiment of the present invention.

FIG. 9 is a sequence diagram illustrating a second example of the flow of the process from scanning to connection establishment in the communication system according to the third example embodiment of the present invention.

FIG. 10 is a sequence diagram illustrating the third example of the flow of the process from scanning to connection establishment in the communication system according to the third example embodiment of the present invention.

FIG. 11 is a sequence diagram illustrating the third example of the flow of the process from scanning to connection establishment in the communication system according to the third example embodiment of the present invention.

FIG. 12 is a diagram illustrating an example configuration of the communication system according to the third example embodiment of the present invention.

FIG. 13 is a diagram for describing an example process carried out by the communication apparatus according to the third example embodiment of the present invention.

FIG. 14 is a diagram for describing an example process carried out by the communication apparatus according to the third example embodiment of the present invention.

FIG. 15 is a diagram for describing an example process carried out by the communication apparatus according to the third example embodiment of the present invention.

FIG. 16 is a diagram for describing an example process carried out by the communication apparatus according to the third example embodiment of the present invention.

FIG. 17 is a diagram for describing an example process carried out by the communication apparatus according to the third example embodiment of the present invention.

FIG. 18 is a diagram for describing an example process carried out by the communication apparatus according to the third example embodiment of the present invention.

FIG. 19 is a diagram for describing an example process carried out by the communication apparatus according to the third example embodiment of the present invention.

FIG. 20 is a diagram for describing an example process carried out by the communication apparatus according to the third example embodiment of the present invention.

FIG. 21 is a diagram for describing an example process carried out by the communication apparatus according to the third example embodiment of the present invention.

FIG. 22 is a diagram for describing an example process carried out by the communication apparatus according to the third example embodiment of the present invention.

FIG. 23 is a block diagram illustrating a computer hardware configuration, which is an example implementation of the communication apparatus according to each of the example embodiments of the present invention.

### EXAMPLE EMBODIMENTS

### First Example Embodiment

A first example embodiment of the present invention will be described in detail with reference to the drawings. The first example embodiment is an embodiment serving as a basis for example embodiments described later.

(Configuration of Communication Apparatus)

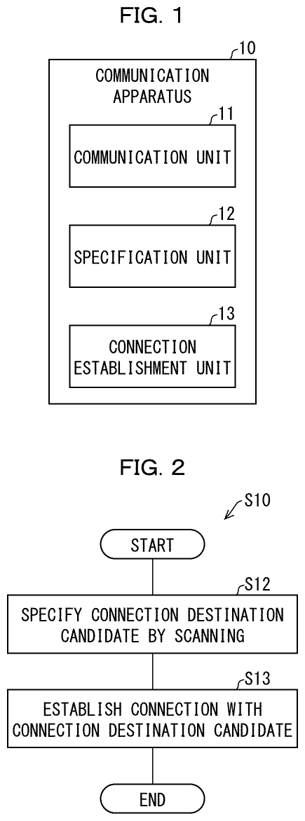

A configuration of a communication apparatus 10 according to the first example embodiment will be described with reference to FIG. 1. FIG. 1 is a block diagram illustrating the configuration of the communication apparatus 10. The communication apparatus 10 according to the first example embodiment includes a communication unit 11, a specification unit 12, and a connection establishment unit 13 as illustrated in FIG. 1.

The communication unit 11, the specification unit 12, and the connection establishment unit 13 are an example implementation of a communication means, a specification means, a connection establishment means, respectively, in the claims.

(Communication Unit 11)

The communication unit 11 is configured to be capable of transmitting and receiving directional communication media. The number of communication units 11 included in the communication apparatus 10 does not limit the first example embodiment. The communication apparatus 10 can be configured to include at least one communication unit 11.

As described above, each of the at least one communication unit 11 is configured to be capable of transmitting and receiving directional communication media. Note here that a specific configuration of a communication unit 11 does not limit the first example embodiment. For example, the communication unit 11 includes a transmission unit that transmits a directional communication medium, and a reception unit that receives a directional communication medium. The communication unit 11 may be configured to include an integrated transmission and reception unit that transmits and receives directional communication media.

A specific example of a directional communication medium that the communication unit 11 uses for communication does not limit the first example embodiment. For example, such a directional communication medium can be exemplified by high frequency domain electromagnetic waves having a frequency of approximately 10 GHz or more. The high frequency domain electromagnetic waves may light, and ultraviolet light.

For example, the communication unit 11 uses the high frequency domain electromagnetic waves as the directional communication medium (described earlier) for communication by directing and transmitting the high frequency domain electromagnetic waves into a predetermined range of angles. Note here that a specific configuration that allows the communication unit 11 to direct the high frequency domain electromagnetic waves does not limit the first example embodiment. For example, the communication unit 11 can be configured to include, for example, the following:
a beamforming antenna for directing and transmitting millimeter waves or submillimeter waves into a predetermined range of angles;
a collimator for collimating infrared light, visible light, or ultraviolet light; and
a laser oscillator for generating a laser of infrared light, visible light, or ultraviolet light.

In a case where the communication unit 11 directs and transmits the high frequency domain electromagnetic waves serving as the communication medium, the communication medium has higher energy density. This enables communication with a more distant communication destination with use of the communication medium.

(Specification Unit 12)

The specification unit 12 specifies at least one connection destination candidate by scanning with use of the communication unit 11. In other words, the specification unit 12 specifies at least one connection destination candidate by transmission or reception of a scanning beam with use of the communication unit 11.

Note here that scanning with use of the directional communication medium (described earlier) is carried out in scanning with use of the communication unit 11. Scanning in the first example embodiment refers to, for example, a search that is carried out to specify at least one connection destination candidate. The wording “scanning” does not attempt to specify, for example, a specific scanning order.

Furthermore, scanning by the specification unit 12 with use of the communication unit 11 includes at least one selected from the group consisting of the following:
transmitting a scanning beam from the communication unit 11 to a scanning range;
transmitting a scanning beam from the communication unit 11 to a scanning range and receiving a response beam that is a response to the scanning beam;
the communication unit 11 receiving a scanning beam transmitted from another apparatus; and
the communication unit 11 receiving a scanning beam transmitted from another apparatus, and transmitting a response beam that is a response to the scanning beam.

Scanning by the specification unit 12 includes, for example, a search for a connection destination candidate whose position is not made clear in advance. More specifically, for example, scanning by the specification unit 12 includes a search for a connection destination candidate for which a direction starting from the communication apparatus 10 is not made clear in advance. In other words, scanning by the specification unit 12 includes a search for a connection destination candidate for which at least one selected from the group consisting of an azimuth angle, an elevation angle, and a depression angle each starting from the communication apparatus 10 is not made clear in advance.

In a case where at least one connection destination candidate whose position is not made clear in advance as described above is searched for, the specification unit 12 specifies the position of the at least one connection destination candidate by scanning with use of the communication unit 11. More specifically, for example, the specification unit 12 uses scanning with use of the communication unit 11 to specify, for the at least one connection destination candidate, the direction starting from the communication apparatus 10. In other words, the specification unit 12 uses scanning with use of the communication unit 11 to specify, for the at least one connection destination candidate, at least one selected from the group consisting of the azimuth angle, the elevation angle, and the depression angle each starting from the communication apparatus 10.

The at least one connection destination candidate that is specified by the specification unit 12 is not limited to a communication apparatus included in a scanning range of scanning with use of the communication unit 11. With reference to a response signal from the communication apparatus included in the scanning range of scanning with use of the communication unit 11, the specification unit 12 can also specify, as a connection destination candidate, a communication apparatus that is specified by the response signal and that is outside the scanning range.

For example, with reference to a response signal from a communication apparatus A included in the scanning range of scanning with use of the communication unit 11, the specification unit 12 can also specify, as a connection destination candidate, a communication apparatus B whose position is specified by the response signal and that is outside the scanning range.

(Connection Establishment Unit 13)

The connection establishment unit 13 establishes connection with the at least one connection destination candidate specified by the specification unit 12. The connection establishment unit 13 generates at least one communication path in a mesh network by establishing the connection. Note here that the connection establishment unit 13 may establish the connection with use of a communication unit that is identical to the at least one communication unit 11 which is included in the communication apparatus 10 and which has been used by the specification unit 12 for scanning, or a communication unit that is partially or entirely different from the at least one communication unit 11 which has been used by the specification unit 12 for scanning.

In any case, the connection establishment unit 13 causes the at least one communication unit 11 included in the communication apparatus 10 to use a directional communication medium to establish connection with the at least one connection destination candidate specified by the specification unit 12.

A process in which the connection is specifically established by the connection establishment unit 13 does not limit the first example embodiment. The process includes, for example, the following process A.
(Process A): A process in which the communication unit 11 of the communication apparatus 10 transmits a directional communication medium to the connection destination candidate specified by the specification unit 12

The process in which the connection is established may be configured to include not only the process A but also the following process B.
(Process B): A process in which as a response to transmission in the process A, a connection destination candidate transmits a directional communication medium to the communication apparatus 10, and the communication unit 11 of the communication apparatus receives the directional communication medium

In the process A, the communication unit 11 of the communication apparatus 10 may be configured to use the directional communication medium to transmit, to the connection destination candidate, connection start information for connection start in accordance with a specific protocol. Alternatively, in the process B, the communication unit 11 of the communication apparatus 10 may be configured to use the directional communication medium to receive, from the connection destination candidate, connection acceptance information in accordance with the specific protocol.

The connection start information may be configured to include identification information for identifying the communication apparatus 10 from another apparatus. The connection acceptance information may be configured to include identification information for identifying the connection destination candidate from another apparatus.

Furthermore, the process in which the connection is established may be configured to include not only the processes A and B but also the following processes C and D.
(Process C): A process in which the connection destination candidate refers to the connection start information that the communication unit 11 of the communication apparatus 10 has transmitted by the directional communication medium in the process A, and the connection destination candidate registers identification information of the communication apparatus 10 in a storage unit included in the connection destination candidate
(Process D): A process in which the communication apparatus refers to the connection acceptance information that the communication unit 11 of the communication apparatus 10 has received by the directional communication medium in the process B, and registers identification information of the connection destination candidate in a storage unit included in the communication apparatus 10

(Effect Brought about by Communication Apparatus 10)

As described above, a configuration is employed such that the communication apparatus 10 according to the first example embodiment includes:
the at least one communication unit 11 that is configured to be capable of transmitting and receiving directional communication media;
the specification unit 12 that specifies at least one connection destination candidate by carrying out scanning with use of the at least one communication unit 11; and
the connection establishment unit 13 that establishes connection with the at least one connection destination candidate specified by the specification unit 12.

According to the communication apparatus 10 configured as described above, even a connection destination candidate whose position is not made clear in advance can be specified by carrying out scanning with use of the communication unit 11. Thus, it is possible to establish communication with the specified connection destination candidate.

A directional communication medium commonly has the following aspects. Specifically, the directional communication medium makes it possible to achieve large-capacity and low-delay communication. In contrast, the directional communication medium is susceptible to influence such as shielding and/or disturbance due to its directionality. The communication apparatus 10 according to the first example embodiment makes it possible to make, in a network in which a directional communication medium is used, adaptive changes including, for example, addition of a communication apparatus and a change in position of the communication apparatus. This makes it possible to configure a network that is less susceptible to influence such as shielding and/or disturbance.

That is, the communication apparatus 10 according to the first example embodiment makes it possible to achieve a robust communication network in which a directional communication medium is used.

(Flow of Communication Method)

A flow of a communication method S10 according to the first example embodiment will be described with reference to FIG. 2. FIG. 2 is a flowchart illustrating the flow of the communication method S10 according to the first example embodiment of the present invention. The communication method S10 includes steps S12 and S13 as illustrated in FIG. 2.

(Step S12)

First, in the step S12, the specification unit 12 specifies at least one connection destination candidate by carrying out scanning with use of the communication unit 11. Note here that scanning with use of the directional communication medium (described earlier) is carried out in scanning with use of the communication unit 11. Since specific details of the process carried out by the specification unit 12 have been described earlier, a description thereof is omitted here.

(Step S13)

Subsequently, in the step S13, the connection establishment unit 13 establishes connection with the at least one connection destination candidate specified by the specification unit 12. Note here that the connection establishment unit 13 may establish the connection with use of a communication unit that is identical to the at least one communication unit 11 which is included in the communication apparatus 10 and which has been used by the specification unit 12 for scanning, or a communication unit that is partially or entirely different from the at least one communication unit 11 which has been used by the specification unit 12 for scanning. Since specific details of the process carried out by the connection establishment unit 13 have been described earlier, a description thereof is omitted here.

(Effect Brought about by Communication Method S10) As described above, a configuration is employed such that the communication apparatus 10 according to the first example embodiment includes:
specifying at least one connection destination candidate by carrying out scanning with use of at least one communication unit 11 that is configured to be capable of transmitting and receiving directional communication media (S12); and
establishing connection with the at least one specified connection destination candidate (S13).

According to the communication method S10 configured as described above, even a connection destination candidate whose position is not made clear in advance can be specified by carrying out scanning with use of the communication unit 11. Thus, it is possible to establish communication with the specified connection destination candidate.

Thus, as in the case of the communication apparatus 10 according to the first example embodiment, the communication method S10 according to the first example embodiment makes it possible to achieve a robust communication network in which a directional communication medium is used.

(Configuration of Communication System)

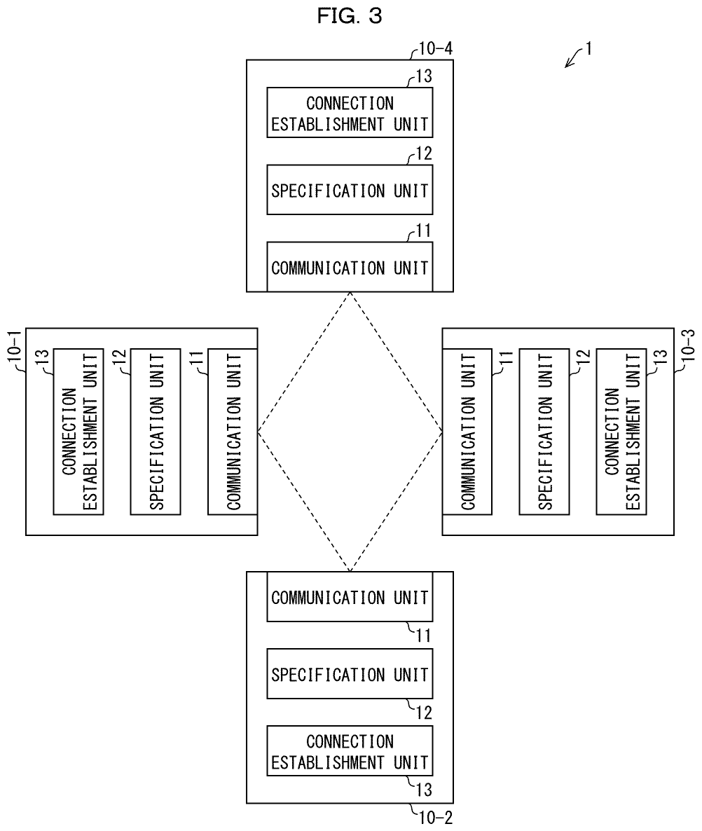

A configuration of a communication system 1 according to the first example embodiment will be described with reference to FIG. 3. FIG. 3 is a block diagram illustrating an example of the configuration of the communication system 1 according to the first example embodiment. The communication system 1 includes, for example, a first communication apparatus 10-1, a second communication apparatus 10-2, a third communication apparatus 10-3, and a fourth communication apparatus as illustrated in FIG. 3.

Note that the example configuration illustrated in FIG. 3 does not limit the communication system 1 according to the first example embodiment. The communication system 1 according to the first example embodiment may be configured to include five or more communication apparatuses, or may be configured to include three or less communication apparatuses.

As illustrated in FIG. 3, the first communication apparatus 10-1, the second communication apparatus 10-2, the third communication apparatus 10-3, and the fourth communication apparatus 10-4 each have a configuration similar to the configuration of the communication apparatus 10 described with reference to FIG. 1.

(Effect Brought about by Communication System 1)

As described above, the communication system 1 according to the first example embodiment includes
a plurality of communication apparatuses (for example, the first communication apparatus 10-1, the second communication apparatus 10-2, the third communication apparatus 10-3, and the fourth communication apparatus), wherein
at least any two or more of the plurality of communication apparatuses each include:
   the at least one communication unit 11 that is configured to be capable of transmitting and receiving directional communication media;
   the specification unit 12 that specifies at least one connection destination candidate by carrying out scanning with use of the at least one communication means; and
   the connection establishment unit 13 that establishes connection with the at least one connection destination candidate specified by the specification means.

According to the communication system 1 configured as described above, even a connection destination candidate whose position is not made clear in advance can be specified by carrying out scanning with use of the communication unit 11. Thus, it is possible to establish communication with the specified connection destination candidate.

Thus, as in the case of the communication apparatus 10 according to the first example embodiment, the communication system 1 according to the first example embodiment makes it possible to achieve a robust communication network in which a directional communication medium is used.

### Second Example Embodiment

A second example embodiment of the present invention will be described in detail with reference to the drawings. Note that members having functions identical to those of the respective members described in the first example embodiment are given respective identical reference numerals, and a description of those members is omitted as appropriate. Note also that a description of the matters described in and shared with the first example embodiment is omitted as appropriate.

(Configuration of Communication Apparatus)

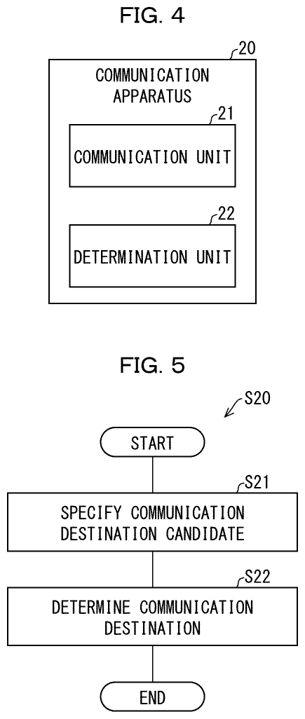

A configuration of a communication apparatus 20 according to the second example embodiment will be described with reference to FIG. 4. FIG. 4 is a block diagram illustrating the configuration of the communication apparatus 20. The communication apparatus 20 according to the second example embodiment includes a communication unit 21 and a determination unit 22 as illustrated in FIG. 4.

The communication unit 21 and the determination unit 22 are an example implementation of a communication means and a determination means, respectively, in the claims.

(Communication Unit 21)

The communication unit 21 is configured to be capable of transmitting and receiving directional communication media. The number of communication units 21 included in the communication apparatus 20 does not limit the second example embodiment. The communication apparatus 20 can be configured to include at least one communication unit 21.

Since a configuration of the communication unit 21 is similar to the configuration of the communication unit 11 according to the first example embodiment, a description thereof is omitted here.

(Determination Unit 22)

The determination unit 22 determines at least one communication destination with which to communicate by the at least one communication unit 21. In the case of determination of communication with a plurality of communication destinations, the determination unit 22 selects the plurality of communication destinations so that an angle between the plurality of communication destinations as viewed from the communication apparatus 2 is not less than a predetermined angle.

Note here that a specific selection process carried out by the determination unit 22 does not limit the second example embodiment. For example, the determination unit 22 can be configured to acquire related information (described in detail in a third example embodiment) related to a communication destination candidate, and carry out the above-described selection with reference to positional information of the communication destination candidate, the positional information being included in the acquired related information.

Alternatively, the determination unit 22 may be configured to specify positional information of a communication destination candidate by a scanning process (described in detail in the third example embodiment) carried out by the communication unit 21 with respect to the communication destination candidate, and carry out the above-described selection with reference to the specified positional information.

Note, however, that at least one communication destination candidate which is specified by the determination unit 22 is not limited to a communication apparatus included in a scanning range of scanning with use of the communication unit 21. With reference to a response signal from the communication apparatus included in the scanning range of scanning with use of the communication unit 21, the determination unit 22 can also specify, as a communication destination candidate, a communication apparatus that is specified by the response signal and that is outside the scanning range.

For example, with reference to a response signal from a communication apparatus A included in the scanning range of scanning with use of the communication unit 21, the determination unit 22 can also specify, as a communication destination candidate, a communication apparatus B whose position is specified by the response signal and that is outside the scanning range.

Note that in the above example, a specific value of the predetermined angle does not limit the second example embodiment. For example, the predetermined angle can be set to approximately 30° to 45°.

(Effect Brought about by Communication Apparatus 20)

As described above, the communication apparatus 20 according to the second example embodiment is configured to include:
the at least one communication unit 21 that is configured to be capable of transmitting and receiving directional communication media; and
the determination unit 22 that determines at least one communication destination with which to communicate by the at least one communication unit 21,
   in the case of determination of communication with a plurality of communication destinations, the determination unit 22 selecting the plurality of communication destinations so that an angle between the plurality of communication destinations as viewed from the communication apparatus is not less than a predetermined angle.

A directional communication medium commonly has the following aspects. Specifically, the directional communication medium, which has a large frequency, can be expected to achieve large-capacity and low-delay communication. In contrast, the directional communication medium is susceptible to influence such as shielding and/or disturbance due to its directionality. Furthermore, in a case where a plurality of communication apparatuses are present in similar directions as viewed from a certain communication apparatus, it is considered that influence of disturbance spreads to each of the plurality of communication apparatuses.

According to the communication apparatus 20 according to the second example embodiment, a communication destination is selected so that an angle between a plurality of communication destinations as viewed from the communication apparatus 20 is not less than a predetermined angle. This brings about an effect of making it possible to minimize influence of disturbance on a communication system including the communication apparatus 20. Thus, according to the communication apparatus 20 according to the second example embodiment, a robust communication network can be achieved while a directional communication medium is used.

(Flow of Communication Method)

A flow of a communication method S20 according to the second example embodiment will be described with reference to FIG. 5. FIG. 5 is a flowchart illustrating a flow of the communication method S20 according to the second example embodiment. The communication method S20 includes steps S21 and S22 as illustrated in FIG. 5.

(Step S21)

First, in the step S21, the determination unit 22 specifies at least one communication destination candidate. For example, the determination unit 22 specifies the at least one communication destination candidate by carrying out scanning with use of the communication unit 21. Note here that for example, scanning with use of the directional communication medium (described earlier) is carried out in scanning with use of the communication unit 21.

(Step S22)

Next, in the step S22, the determination unit 22 selects at least one communication destination from among the at least one communication destination candidate specified in the step S21. Note here that in the case of determination of communication with a plurality of communication destinations, the determination unit 22 selects the plurality of communication destinations so that an angle between the plurality of communication destinations as viewed from the communication apparatus 2 is not less than a predetermined angle. Since specific details of the process carried out by the determination unit 22 have been described earlier, a description thereof is omitted here.

(Effect Brought about by Communication Method S20)

As described above, the communication method S20 according to the second example embodiment is configured to include
determining at least one communication destination of the communication apparatus 20 including the at least one communication unit 21 that is configured to be capable of transmitting and receiving directional communication media (the step S22), wherein
in the determining,
   in the case of determination of communication with a plurality of communication destinations, the plurality of communication destinations are selected so that an angle between the plurality of communication destinations as viewed from the communication apparatus is not less than a predetermined angle.

According to the communication method S20 according to the second example embodiment, a communication destination is selected so that an angle between a plurality of communication destinations as viewed from the communication apparatus 20 is not less than a predetermined angle. This brings about an effect of making it possible to minimize influence of disturbance on a communication system including the communication apparatus 20. Thus, according to the communication method S20 according to the second example embodiment, a robust communication network can be achieved while a directional communication medium is used.

(Configuration of Communication System 2)

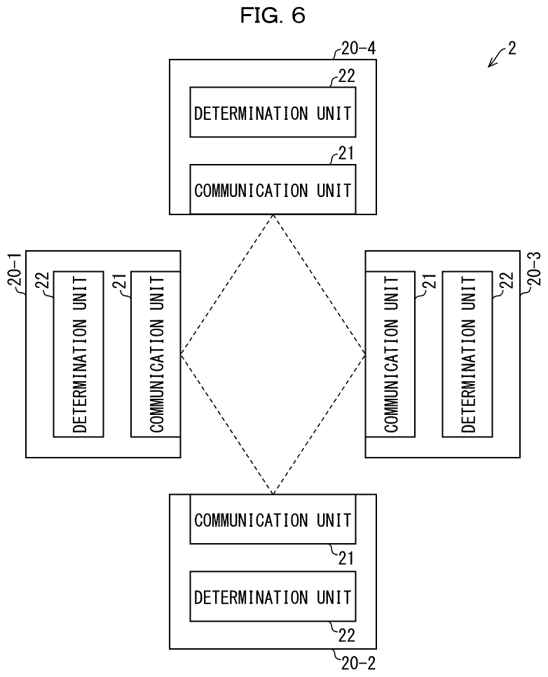

A configuration of a communication system 2 according to the second example embodiment will be described with reference to FIG. 6. FIG. 6 is a block diagram illustrating an example of the configuration of the communication system 2 according to the second example embodiment. The communication system 2 includes, for example, a first communication apparatus 20-1, a second communication apparatus 20-2, a third communication apparatus 20-3, and a fourth communication apparatus as illustrated in FIG. 6.

Note that the example configuration illustrated in FIG. 6 does not limit the communication system 2 according to the second example embodiment. The communication system 2 according to the second example embodiment may be configured to include five or more communication apparatuses, or may be configured to include three or less communication apparatuses.

As illustrated in FIG. 6, the first communication apparatus 20-1, the second communication apparatus 20-2, the third communication apparatus 20-3, and the fourth communication apparatus 20-4 each have a configuration similar to the configuration of the communication apparatus 20 described with reference to FIG. 4.

(Effect Brought about by Communication System 2)

As described above, the communication system 2 according to the second example embodiment includes
a plurality of communication apparatuses (for example, the first communication apparatus 20-1, the second communication apparatus 20-2, the third communication apparatus 20-3, and the fourth communication apparatus), wherein
at least any two or more of the plurality of communication apparatuses each include:
   the at least one communication unit 21 that is configured to be capable of transmitting and receiving directional communication media; and the determination unit 22 that determines at least one communication destination with which to communicate by the at least one communication unit 21, in the case of determination of communication with a plurality of communication destinations, the determination unit 22 selecting the plurality of communication destinations so that an angle between the plurality of communication destinations as viewed from a corresponding communication apparatus 20 is not less than a predetermined angle.

According to the communication system 2 according to the second example embodiment, a communication destination is selected so that an angle between a plurality of communication destinations as viewed from a communication apparatus included in the communication system 2 is not less than a predetermined angle. This brings about an effect of making it possible to minimize influence of disturbance on the communication system 2. Thus, according to the communication system 2 according to the second example embodiment, a robust communication system 2 can be achieved while a directional communication medium is used.

(First Variation of Second Example Embodiment)

The following description will discuss a first variation of the second example embodiment.

(Configuration of Communication Apparatus)

The communication apparatus 20 according to the first variation has a schematic configuration similar to that illustrated in FIG. 4 (described earlier). As in the case of the communication apparatus 20 according to the second example embodiment, the communication apparatus 20 according to the first variation schematically includes the communication unit 21 and the determination unit 22 as illustrated in FIG. 4.

The communication unit 21 and the determination unit 22 are an example implementation of the communication means and the determination means, respectively, in the claims.

(Communication Unit 21)

The communication unit 21 according to the first variation is configured to be capable of transmitting and receiving directional communication media. The number of communication units 21 included in the communication apparatus 20 does not limit the first variation. The communication apparatus 20 can be configured to include at least one communication unit 21.

Since a configuration of the communication unit 21 is similar to the configuration of the communication unit 11 according to the first example embodiment, a description thereof is omitted here.

(Determination Unit 22)

The determination unit 22 determines at least one communication destination with which to communicate by the at least one communication unit 21. In a case where a communication destination candidate is present in a range of predetermined angles from a connected communication destination, the determination unit 22 lowers priority of the communication destination candidate.

Note here that a specific selection process carried out by the determination unit 22 does not limit the first variation. For example, the determination unit 22 can be configured to acquire related information (described in detail in the third example embodiment) related to a communication destination candidate, and carry out the above-described selection with reference to positional information of the communication destination candidate, the positional information being included in the acquired related information.

Alternatively, the determination unit 22 may be configured to specify positional information of a communication destination candidate by a scanning process (described in detail in the third example embodiment) carried out by the communication unit 21 with respect to the communication destination candidate, and carry out the above-described selection with reference to the specified positional information.

Note, however, that at least one communication destination candidate which is specified by the determination unit 22 is not limited to a communication apparatus included in a scanning range of scanning with use of the communication unit 21. With reference to a response signal from the communication apparatus included in the scanning range of scanning with use of the communication unit 21, the determination unit 22 can also specify, as a communication destination candidate, a communication apparatus that is specified by the response signal and that is outside the scanning range.

For example, with reference to a response signal from a communication apparatus A included in the scanning range of scanning with use of the communication unit 21, the determination unit 22 can also specify, as a communication destination candidate, a communication apparatus B whose position is specified by the response signal and that is outside the scanning range.

Note that in the above example, a specific value of the predetermined angle does not limit the second example embodiment. For example, the predetermined angle can be set to approximately 30° to 45°.

(Effect Brought about by Communication Apparatus 20)

As described above, the communication apparatus 20 according to the first variation is configured to include:
the at least one communication unit 21 that is configured to be capable of transmitting and receiving directional communication media; and
the determination unit 22 that determines at least one communication destination with which to communicate by the at least one communication unit 21,
   the determination unit 22 determining priority of at least one communication destination with which to communicate by the at least one communication means. In so doing, in a case where a communication destination candidate is present in a range of predetermined angles from a connected communication destination, the determination unit 22 lowers priority of the communication destination candidate.

According to the communication apparatus 20 according to the first variation, in a case where a communication destination candidate is present in a range of predetermined angles from a connected communication destination, priority of the communication destination candidate is lowered. This brings about an effect of making it possible to minimize influence of disturbance on the communication system. Thus, according to the communication apparatus 20 according to the second example embodiment, a robust communication network can be achieved while a directional communication medium is used.

(Flow of Communication Method)

The communication method S20 according to the first variation has a schematic flow similar to that illustrated in FIG. 5 (described earlier). As in the case of the second example embodiment, the communication method S20 according to the first variation schematically includes the steps S21 and S22 as illustrated in FIG. 5.

(Step S21)

First, in the step S21, the determination unit 22 specifies at least one communication destination candidate. For example, the determination unit 22 specifies the at least one communication destination candidate by carrying out scanning with use of the communication unit 21. Note here that for example, scanning with use of the directional communication medium (described earlier) is carried out in scanning with use of the communication unit 21.

(Step S22)

Next, in the step S22, the determination unit 22 selects at least one communication destination from among the at least one communication destination candidate specified in the step S21. Note here that in a case where a communication destination candidate is present in a range of predetermined angles from a connected communication destination, the determination unit 22 lowers priority of the communication destination candidate. Since specific details of the process carried out by the determination unit 22 have been described earlier, a description thereof is omitted here.

(Effect Brought about by Communication Method S20)

As described above, the communication method S20 according to the first variation is configured to include
determining at least one communication destination of the communication apparatus 20 including the at least one communication unit 21 that is configured to be capable of transmitting and receiving directional communication media (the step S22), wherein
in the determining,
   in a case where a communication destination candidate is present in a range of predetermined angles from a connected communication destination, priority of the communication destination candidate is lowered.

According to the communication method S20 according to the first variation, in a case where a communication destination candidate is present in a range of predetermined angles from a connected communication destination, priority of the communication destination candidate is lowered. This brings about an effect of making it possible to minimize influence of disturbance on the communication system 2. Thus, according to the communication method S20 according to the second example embodiment, a robust communication network can be achieved while a directional communication medium is used.

(Configuration of Communication System 2)

The communication system 2 according to the first variation has a configuration that is schematically similar to the configuration illustrated in FIG. 6 (described earlier). The communication system 2 according to the first variation includes, for example, the first communication apparatus 20-1, the second communication apparatus 20-2, the third communication apparatus 20-3, and the fourth communication apparatus as illustrated in FIG. 6.

As illustrated in FIG. 6, the first communication apparatus 20-1, the second communication apparatus 20-2, the third communication apparatus 20-3, and the fourth communication apparatus 20-4 each have a configuration similar to the configuration of the communication apparatus 20 according to the first variation.

(Effect Brought about by Communication System 2)

As described above, the communication system 2 according to the first variation is configured to include
a plurality of communication apparatuses (for example, the first communication apparatus 20-1, the second communication apparatus 20-2, the third communication apparatus 20-3, and the fourth communication apparatus), wherein
at least any two or more of the plurality of communication apparatuses each include:
   the at least one communication unit 21 that is configured to be capable of transmitting and receiving directional communication media; and the determination unit 22 that determines at least one communication destination with which to communicate by the at least one communication unit 21, in a case where a communication destination candidate is present in a range of predetermined angles from a connected communication destination, the determination unit 22 lowering priority of the communication destination candidate.

According to the communication system 2 according to the first variation, in a case where a communication destination candidate is present in a range of predetermined angles from a connected communication destination, priority of the communication destination candidate is lowered. This brings about an effect of making it possible to minimize influence of disturbance on the communication system 2. Thus, according to the communication system 2 according to the second example embodiment, a robust communication system 2 can be achieved while a directional communication medium is used.

(Second Variation of Second Example Embodiment)

The following description will discuss a second variation of the second example embodiment.

(Configuration of Communication Apparatus)

The communication apparatus 20 according to the second variation has a schematic configuration similar to that illustrated in FIG. 4 (described earlier). As in the case of the communication apparatus 20 according to the second example embodiment, the communication apparatus 20 according to the second variation schematically includes the communication unit 21 and the determination unit 22 as illustrated in FIG. 4.

The communication unit 21 and the determination unit 22 are an example implementation of the communication means and the determination means, respectively, in the claims.

(Communication Unit 21)

The communication unit 21 is configured to be capable of transmitting and receiving directional communication media. The number of communication units 21 included in the communication apparatus 20 does not limit the second variation. The communication apparatus 20 can be configured to include at least one communication unit 21.

Since a configuration of the communication unit 21 is similar to the configuration of the communication unit 11 according to the first example embodiment, a description thereof is omitted here.

(Determination Unit 22)

The determination unit 22 determines at least one communication destination with which to communicate by the at least one communication unit 21. The determination unit 22 determines the at least one communication destination from among at least one communication destination candidate with reference to positional information of the at least one communication destination candidate.

Note here that a specific selection process carried out by the determination unit 22 does not limit the second variation. For example, the determination unit 22 can be configured to acquire related information (described in detail in the third example embodiment) related to a communication destination candidate, and carry out the above-described selection with reference to positional information of the communication destination candidate, the positional information being included in the acquired related information.

Alternatively, the determination unit 22 may be configured to specify positional information of a communication destination candidate by a scanning process (described in detail in the third example embodiment) carried out by the communication unit 21 with respect to the communication destination candidate, and carry out the above-described selection with reference to the specified positional information.

Note, however, that at least one communication destination candidate which is specified by the determination unit 22 is not limited to a communication apparatus included in a scanning range of scanning with use of the communication unit 21. With reference to a response signal from the communication apparatus included in the scanning range of scanning with use of the communication unit 21, the determination unit 22 can also specify, as a communication destination candidate, a communication apparatus that is specified by the response signal and that is outside the scanning range.

For example, with reference to a response signal from a communication apparatus A included in the scanning range of scanning with use of the communication unit 21, the determination unit 22 can also specify, as a communication destination candidate, a communication apparatus B whose position is specified by the response signal and that is outside the scanning range.

Note that in the above description, a specific method in which the communication destination candidate is determined by the determination unit 22 does not limit the second variation. For example, the determination unit 22 may be configured such that with reference to positional information of a plurality of communication destination candidates, the determination unit 22 determines, as the at least one communication destination, at least one communication destination candidate whose distance from the communication apparatus 20 is in a predetermined range.

(Effect Brought about by Communication Apparatus 20)

As described above, the communication apparatus 20 according to the second variation is configured to include:
the at least one communication unit 21 that is configured to be capable of transmitting and receiving directional communication media; and
the determination unit 22 that determines at least one communication destination with which to communicate by the at least one communication unit 21,
   the determination unit 22 determining the at least one communication destination from among at least one communication destination candidate with reference to positional information of the at least one communication destination candidate.

According to the communication apparatus 20 according to the second variation, the at least one communication destination is determined from among at least one communication destination candidate with reference to positional information of the at least one communication destination candidate. This brings about an effect of making it possible to configure a robust communication system including a communication apparatus that is suitably disposed.

(Flow of Communication Method)

The communication method S20 according to the second variation has a schematic flow similar to that illustrated in FIG. 5 (described earlier). As in the case of the second example embodiment, the communication method S20 according to the second variation schematically includes the steps S21 and S22 as illustrated in FIG. 5.

(Step S21)

First, in the step S21, the determination unit 22 specifies at least one connection destination candidate. For example, the determination unit 22 specifies the at least one connection destination candidate by carrying out scanning with use of the communication unit 21. Note here that for example, scanning with use of the directional communication medium (described earlier) is carried out in scanning with use of the communication unit 21.

(Step S22)

Next, in the step S22, the determination unit 22 selects at least one communication destination from among the at least one communication destination candidate specified in the step S21. Note here that the determination unit 22 determines the at least one communication destination from among at least one communication destination candidate with reference to positional information of the at least one communication destination candidate. Since specific details of the process carried out by the determination unit 22 have been described earlier, a description thereof is omitted here.

(Effect Brought about by Communication Method S20)

As described above, the communication method S20 according to the second variation is configured to include
determining at least one communication destination of the communication apparatus 20 including the at least one communication unit 21 that is configured to be capable of transmitting and receiving directional communication media (the step S22), wherein
in the determining,
   the at least one communication destination is determined from among at least one communication destination candidate with reference to positional information of the at least one communication destination candidate.

According to the communication method S20 according to the second variation, the at least one communication destination is determined from among at least one communication destination candidate with reference to positional information of the at least one communication destination candidate. This brings about an effect of making it possible to configure a robust communication system including a communication apparatus that is suitably disposed.

(Configuration of Communication System 2)

The communication system 2 according to the second variation has a configuration that is schematically similar to the configuration illustrated in FIG. 6 (described earlier). The communication system 2 according to the second variation includes, for example, the first communication apparatus 20-1, the second communication apparatus 20-2, the third communication apparatus 20-3, and the fourth communication apparatus as illustrated in FIG. 6.

As illustrated in FIG. 6, the first communication apparatus 20-1, the second communication apparatus 20-2, the third communication apparatus 20-3, and the fourth communication apparatus 20-4 each have a configuration similar to the configuration of the communication apparatus 20 according to the second variation.

(Effect Brought about by Communication System 2)

As described above, the communication system 2 according to the second variation is configured to include
a plurality of communication apparatuses (for example, the first communication apparatus 20-1, the second communication apparatus 20-2, the third communication apparatus 20-3, and the fourth communication apparatus), wherein
at least any two or more of the plurality of communication apparatuses each include:
   the at least one communication unit 21 that is configured to be capable of transmitting and receiving directional communication media; and the determination unit 22 that determines at least one communication destination with which to communicate by the at least one communication unit 21, the determination unit 22 determining the at least one communication destination from among at least one communication destination candidate with reference to positional information of the at least one communication destination candidate.

According to the communication system 2 according to the second variation, the at least one communication destination is determined from among at least one communication destination candidate with reference to positional information of the at least one communication destination candidate. This brings about an effect of making it possible to configure a robust communication system 2 including a communication apparatus that is suitably disposed.

### Third Example Embodiment

A third example embodiment of the present invention will be described in detail with reference to the drawings. Note that members having functions identical to those of the respective members described in the first example embodiment are given respective identical reference numerals, and a description of those members is omitted as appropriate.

(Configuration of Communication Apparatus)

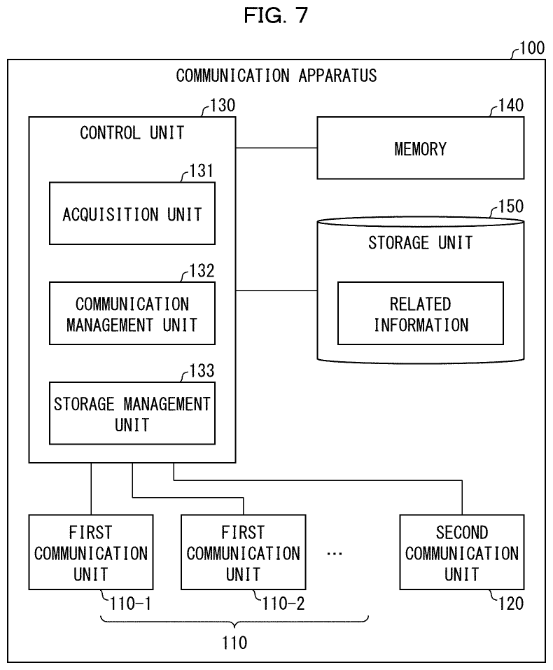

A configuration of a communication apparatus 100 according to the third example embodiment will be described with reference to FIG. 7. FIG. 7 is a block diagram illustrating the configuration of the communication apparatus 100. The communication apparatus 100 according to the third example embodiment includes a first communication unit 110, a second communication unit 120, a control unit 130, a memory 140, and a storage unit 150 as illustrated in FIG. 7.

Note here that the first communication unit 110 is an example implementation of the communication means in the claims.

(First Communication Unit 110)

The first communication unit 110 is configured to be capable of transmitting and receiving directional communication media. The first communication unit 110 is constituted by, for example, a plurality of communication units such as a communication unit 110-1, a communication unit 110-2, . . . as illustrated in FIG. 7.

As described above, each of the communication units 110-1, 110-2, . . . is configured to be capable of transmitting and receiving directional communication media. Note here that a specific configuration of each of the communication units 110-1, 110-2, . . . does not limit the third example embodiment. For example, each of the communication units 110-1, 110-2, . . . includes a transmission unit that transmits a directional communication medium, and a reception unit that receives a directional communication medium. Each of the communication units 110-1, 110-2, . . . may be configured to include an integrated transmission and reception unit that transmits and receives directional communication media.

A specific example of a directional communication medium that the first communication unit 110 uses for communication does not limit the third example embodiment. For example, as in the case of the first example embodiment, such a directional communication medium can be exemplified by high frequency domain electromagnetic waves having a frequency of approximately 10 GHz or more. The high frequency domain electromagnetic waves may light, and ultraviolet light.

For example, the first communication unit 110 uses the high frequency domain electromagnetic waves as the directional communication medium (described earlier) for communication by directing and transmitting the high frequency domain electromagnetic waves into a predetermined range of angles. Note here that a specific configuration that allows the first communication unit 110 to direct the high frequency domain electromagnetic waves does not limit the third example embodiment. For example, as in the case of the first example embodiment, each of the communication units 110-1, 110-2, . . . constituting the first communication unit 110 can be configured to include, for example, the following:
a beamforming antenna for directing and transmitting millimeter waves or submillimeter waves into a predetermined range of angles;
a collimator for collimating infrared light, visible light, or ultraviolet light; and
a laser oscillator for generating a laser of infrared light, visible light, or ultraviolet light.

The communication units 110-1, 110-2, . . . each constituting the first communication unit 110 may be directed so as to carry out transmission and reception in ranges different from each other. For example, the communication units 110-1, 110-2, . . . may be directed such that the communication unit 110-1 is to carry out transmission and reception in a range of azimuth angles of 0° to 90°, the communication unit 110-2 is to carry out transmission and reception in a range of azimuth angles of 90° to 180°, the communication unit 110-3 is to carry out transmission and reception in a range of azimuth angles 180° to 270°, and the communication unit 110-4 is to carry out transmission and reception in a range of azimuth angles 270° to 360°.

(Second Communication Unit 120)

The second communication unit 120 is configured to carry out communication with use of a communication medium different from the directional communication medium used by the first communication unit 120 for communication. For example, the second communication unit 120 communicates with another apparatus such as a server via, for example, a wired or wireless local area network, or a global network. Furthermore, the second communication unit 120 may be configured to function as an acquisition means that acquires, from another communication apparatus or another apparatus such as a server, related information related to the another communication apparatus.

(Control Unit 130)

The control unit 130 includes an acquisition unit 131, a communication management unit 132, and a storage management unit 133 as illustrated in FIG. 7. The acquisition unit 131 is an example implementation of the acquisition means in the claims. The communication management unit 132 is an example implementation of the specification means, the connection establishment means, a judgment means, and the provision means in the claims. The storage management unit 133 is an example implementation of a storage means in the claims.

(Acquisition Unit 131)

The acquisition unit 131 acquires related information related to a communication destination with which to communicate by the first communication unit 110. Note here that the communication destination with which to communicate by the first communication unit 110 includes at least one selected from the group consisting of the following:
at least one connection destination candidate specified by causing the communication management unit 132 (described later) to carry out scanning with use of the first communication unit 110; and
among the specified at least one connection destination candidate, a connection destination with connection established by the communication management unit 132.

The related information acquired by the acquisition unit 131 will be described later.

(Communication Management Unit 132)

The communication management unit 132 manages a communication process in which the first communication unit 110 is used. For example, the communication management unit 132 carries out, for example, the following processes:
scanning with use of the first communication unit 110;
establishment of connection with use of the first communication unit 110;
disconnection with use of the first communication unit 110; and
switching of connection with use of the first communication unit 110.

A specific example process carried out by the communication management unit 132 will be described later.

(Storage Management Unit 133)

The storage management unit 133 manages a process of storage in the storage unit 150. For example, the storage management unit 133 stores, in the storage unit 150, the related information acquired by the acquisition unit 131. The storage management unit 133 also reads various kinds of information stored in the storage unit 150, and provides the information to each unit of the control unit 130.

(Flow from Scanning to Connection Establishment)

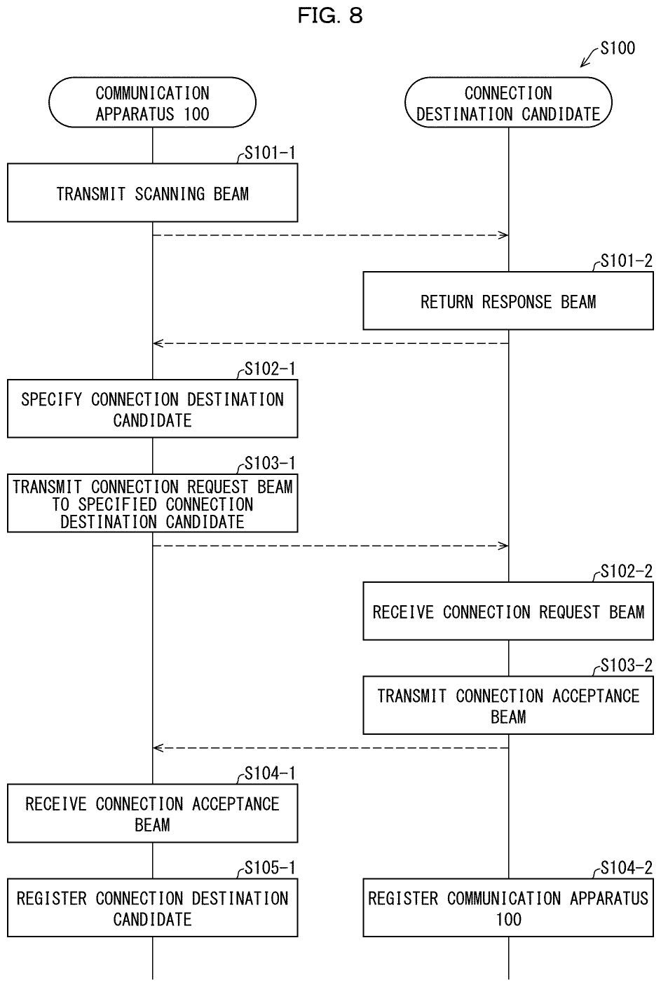

Subsequently, a flow of a process from implementation of scanning with use of the first communication unit 110 to connection establishment, the process being carried out by the communication management unit 132, will be described with reference to FIGS. 8 to 11.

(First Example of Flow from Scanning to Connection Establishment)

FIG. 8 is a sequence diagram illustrating a first example of the flow of the process from scanning with use of the first communication unit 110 to connection establishment, the process being carried out by the communication management unit 132. The first example is an example of a case where the communication apparatus 100 transmits a scanning beam first, and connection with a connection destination candidate present in a scanning target range is established.

(Step S101-1)

In a step S101-1, the communication management unit 132 uses the first communication unit 110 to transmit a scanning beam with a predetermined scanning range as a target. The transmitted scanning beam reaches a connection destination candidate present in the predetermined scanning range.

(Step S101-2)

In a step S101-2, the connection destination candidate existing in the scanning range returns a response beam as a response to the scanning beam to the communication apparatus 100. The returned response beam reaches the communication apparatus 100.

Note that a specific configuration for the connection destination candidate to return the response beam does not limit the third example embodiment. For example, the connection destination candidate may be configured to include a corner cube reflector, use the corner cube reflector to reflect a scanning beam, and return the reflected scanning beam as a response beam to the communication apparatus 100. As another example, the connection destination candidate may be configured to include a receiving apparatus that receives a scanning beam, and a transmitting apparatus that transmits a response beam in a direction in which the scanning beam has been received.

(Step S102-1)

In a step S102-1, the communication management unit 132 specifies a communication destination candidate with reference to the response beam received from the connection destination candidate.

For example, the communication management unit 132 specifies a position of the connection destination candidate in accordance with a direction of the received response beam. More specifically, the communication management unit 132 specifies, in accordance with the direction of the received response beam, a direction of the connection destination candidate as viewed from the communication apparatus 100. In other words, the communication management unit 132 specifies, in accordance with the direction of the received response beam, at least one selected from the group consisting of an azimuth angle, an elevation angle, and a depression angle of the connection destination candidate as viewed from the communication apparatus 100.

(Step S103-1)

In a step S103-1, the communication management unit 132 transmits a connection request beam to the connection destination candidate specified in the step S102-1. The connection request beam may be configured to include, for example, not only information indicative of a request for connection but also identification information for identifying the communication apparatus 100 from another apparatus. The connection request beam may also be configured to include related information managed by the storage management unit 133 and pertaining to the communication apparatus 100 and another communication apparatus.

(Step S102-2)

In a step S102-2, the connection destination candidate receives the connection request beam transmitted in the step S103-1. The connection destination candidate specifies the communication apparatus 100 with reference to the connection request beam transmitted in the step S103-1. For example, the connection destination candidate specifies a position of the communication apparatus 100 in accordance with the direction of the received connection request beam. More specifically, the connection destination candidate specifies, in accordance with the direction of the received connection request beam, the direction of the communication apparatus 100 as viewed from the connection destination candidate. In other words, the connection destination candidate specifies, in accordance with the direction of the received connection request beam, at least one selected from the group consisting of an azimuth angle, an elevation angle, and a depression angle of the communication apparatus 100 as viewed from the connection destination candidate.

(Step S103-2)

In a step S103-2, the connection destination candidate transmits a connection acceptance beam to the communication apparatus 100. The connection acceptance beam may be configured to include not only information indicative of acceptance of connection but also identification information for identifying the connection destination candidate from another apparatus. The connection acceptance beam may also be configured to include related information related to the connection destination candidate and the another communication apparatus.

(Step S104-1)

In a step S104-1, the communication management unit 132 receives the connection acceptance beam transmitted in the step S103-2.

(Step S105-1)

In a step S105-1, the storage management unit 133 registers the connection destination candidate as a connection destination with reference to the connection acceptance beam received in the step S104-1. For example, the storage management unit 133 stores, in the storage unit, identification information of the connection destination candidate, the identification information being included in the connection acceptance beam. For example, the step S105-1 results in establishment of connection from the communication apparatus 100 to the connection destination candidate.

(Step S104-2)

In a step S104-2, the connection destination candidate refers to the connection request beam received in the step S102-2, and registers the communication apparatus 100 as a connection destination. For example, the connection destination candidate stores, in a storage unit included in the connection destination candidate, identification information of the communication apparatus 100, the identification information being included in the connection request beam. For example, the step S104-2 results in establishment of connection from the connection destination candidate to the communication apparatus 100.

(Second Example of Flow from Scanning to Connection Establishment)

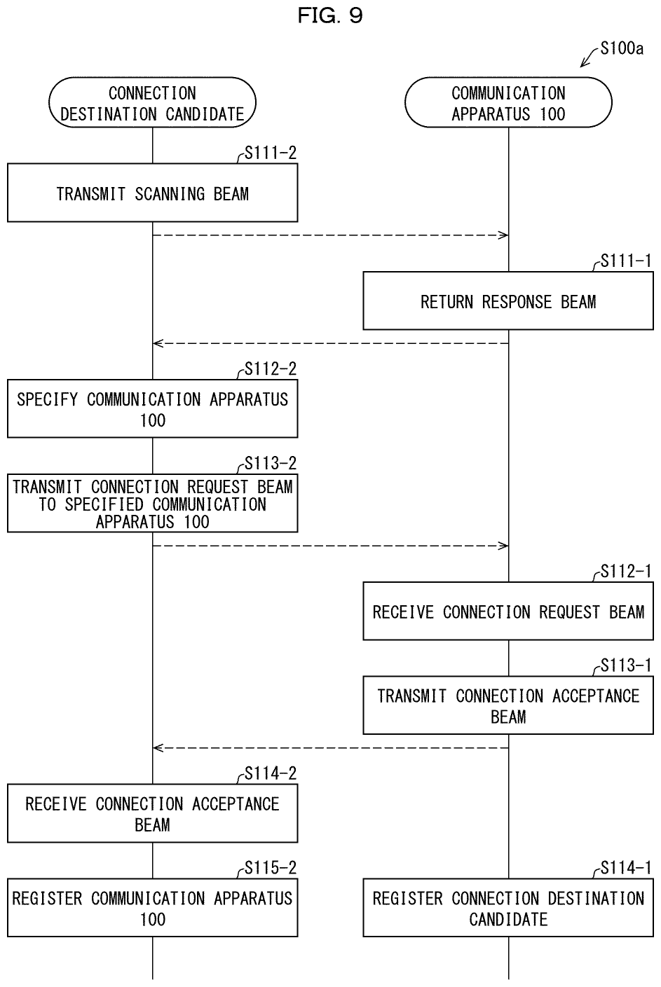

FIG. 9 is a sequence diagram illustrating a second example of the flow of the process from scanning with use of the first communication unit 110 to connection establishment, the process being carried out by the communication management unit 132. The second example is an example of a case where a connection destination candidate transmits a scanning beam first, and connection with the communication apparatus 100 present in a scanning target range is established.

As illustrated in FIG. 9, the process of the flow from scanning to connection establishment according to the fourth example is obtained by exchanging the communication apparatus 100 and the connection destination candidate in the process which has been described with reference to FIG. 8 and in which the communication apparatus 100 and the connection destination are connected. Since processes illustrated in FIG. 9 and carried out in respective steps are clear with reference to FIG. 8, a specific description thereof is omitted here.

(Third Example of Flow from Scanning to Connection Establishment)

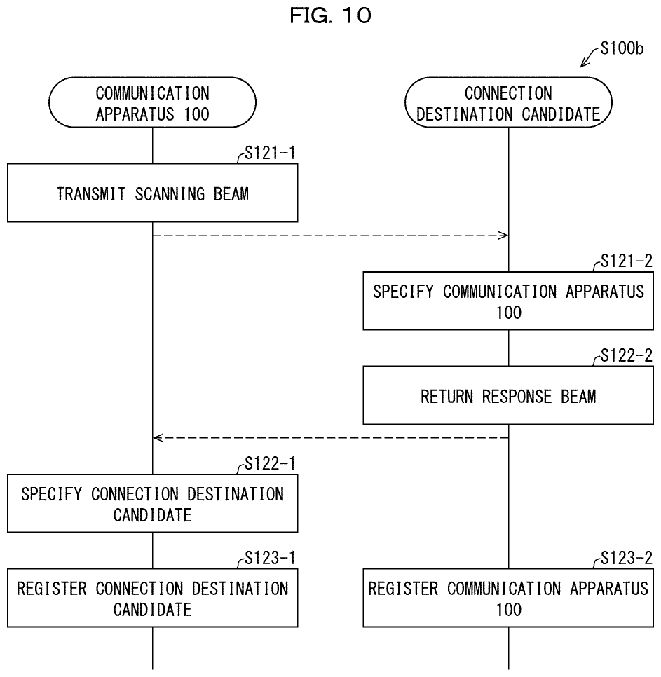

FIG. 10 is a sequence diagram illustrating a third example of the flow of the process from scanning with use of the first communication unit 110 to connection establishment, the process being carried out by the communication management unit 132. The third example is an example of a case where the communication apparatus 100 transmits a scanning beam first, and connection with a connection destination candidate present in a scanning target range is established.

(Third Example of Flow from Scanning to Connection Establishment)

FIG. 10 is a sequence diagram illustrating a third example of the flow of the process from scanning with use of the first communication unit 110 to connection establishment, the process being carried out by the communication management unit 132. The third example is an example of a case where the communication apparatus 100 transmits a scanning beam first, and connection with a connection destination candidate present in a scanning target range is established.

(Step S121-1)

In a step S121-1, the communication management unit 132 uses the first communication unit 110 to transmit a scanning beam with a predetermined scanning range as a target. The transmitted scanning beam reaches a connection destination candidate present in the predetermined scanning range.

The scanning beam transmitted in the step S121-1 may be configured to include, for example, not only information indicative of a request for connection but also identification information for identifying the communication apparatus 100 from another apparatus. The scanning beam may also be configured to include related information managed by the storage management unit 133 and pertaining to the communication apparatus 100 and another communication apparatus.

(Step S121-2)

In a step S121-2, the connection destination candidate specifies the communication apparatus 100 with reference to the scanning beam transmitted in the step S121-1. For example, the connection destination candidate specifies the position of the communication apparatus 100 in accordance with a direction of the scanning beam transmitted in the step S121-1. More specifically, the connection destination candidate specifies, in accordance with the direction of the received scanning beam, the direction of the communication apparatus 100 as viewed from the connection destination candidate. In other words, the connection destination candidate specifies, in accordance with the direction of the received scanning beam, at least one selected from the group consisting of an azimuth angle, an elevation angle, and a depression angle of the communication apparatus 100 as viewed from the connection destination candidate.

Furthermore, in the step S121-2, the connection destination candidate may be configured to specify the communication apparatus 100 with further reference to the identification information of the communication apparatus 100, the identification information being included in the scanning beam.

(Step S122-2)

In a step S122-2, the connection destination candidate transmits, to the communication apparatus 100, a response beam as a response to the scanning beam transmitted in S121-2. The transmitted response beam reaches the communication apparatus 100.

The response beam transmitted in the step S122-2 may be configured to include, for example, not only information indicative of acceptance of connection but also identification information for identifying the connection destination candidate from another apparatus. The response beam may also be configured to include related information managed by the connection destination candidate and pertaining to the connection destination candidate and another communication apparatus.

(Step S122-1)

In a step S122-1, the communication management unit 132 specifies the connection destination candidate with reference to the response beam transmitted in the step S122-2.

For example, the communication management unit 132 specifies a position of the connection destination candidate in accordance with a direction of the received response beam. More specifically, the communication management unit 132 specifies, in accordance with the direction of the received response beam, a direction of the connection destination candidate as viewed from the communication apparatus 100. In other words, the communication management unit 132 specifies, in accordance with the direction of the received response beam, at least one selected from the group consisting of an azimuth angle, an elevation angle, and a depression angle of the connection destination candidate as viewed from the communication apparatus 100.

Furthermore, in the step S122-1, the communication management unit 132 may be configured to specify the connection destination candidate with further reference to the identification information of the connection destination candidate, the identification information being included in the response beam.

(Step S123-1)

In a step S123-1, the storage management unit 133 registers the connection destination candidate as a connection destination with reference to the response beam received from the connection destination candidate. For example, the storage management unit 133 stores, in the storage unit, the identification information of the connection destination candidate, the identification information being included in the response beam. For example, the step S123-1 results in establishment of connection from the communication apparatus 100 to the connection destination candidate.

(Step S123-2)

In a step S123-2, the connection destination candidate registers the communication apparatus 100 as the connection destination with reference to the scanning beam received from the communication apparatus 100. For example, the connection destination candidate stores, in the storage unit included in the connection destination candidate, the identification information of the communication apparatus 100, the identification information being included in the scanning beam. For example, the step S123-2 results in establishment of connection from the connection destination candidate to the communication apparatus 100.

(Fourth Example of Flow from Scanning to Connection Establishment)

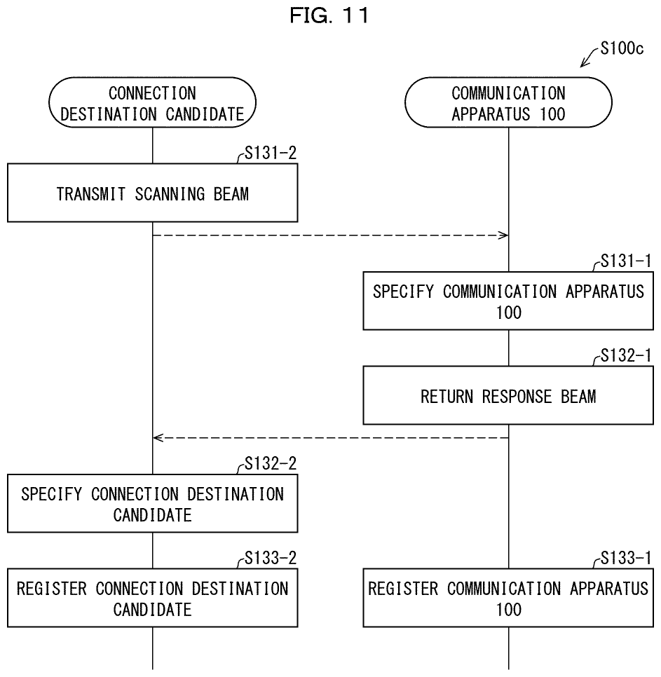

FIG. 11 is a sequence diagram illustrating a fourth example of the flow of the process from scanning with use of the first communication unit 110 to connection establishment, the process being carried out by the communication management unit 132. The fourth example is an example of a case where a connection destination candidate transmits a scanning beam first, and connection with the communication apparatus 100 present in a scanning target range is established.

As illustrated in FIG. 11, the process of the flow from scanning to connection establishment according to the fourth example is obtained by exchanging the communication apparatus 100 and the connection destination candidate in the process which has been described with reference to FIG. 10 and in which the communication apparatus 100 and the connection destination are connected. Since processes illustrated in FIG. 11 and carried out in respective steps are clear with reference to FIG. 10, a specific description thereof is omitted here.

The above description has discussed the examples of the flow of the process from scanning to connection establishment. Note, however, that the examples described above do not limit the third example embodiment.

For example, in the second example described earlier, the communication apparatus 100 may establish connection with a communication destination candidate (referred to as “communication destination candidate B” for convenience) that is different from a communication destination candidate (referred to as “communication destination candidate A” for convenience) which has transmitted the scanning beam. In such a case, for example, the communication apparatus 100 may be configured to refer to the related information included in the connection request beam transmitted in the step S113-2, specify the communication destination candidate B, and establish connection with the specified communication destination candidate B.

Similarly, in the fourth example described earlier, the communication apparatus 100 may establish connection with a communication destination candidate (referred to as “communication destination candidate B” for convenience) that is different from a communication destination candidate (referred to as “communication destination candidate A” for convenience) which has transmitted the scanning beam. In such a case, for example, the communication apparatus 100 may be configured to refer to the related information included in the scanning beam transmitted in the step S131-2, specify the communication destination candidate B, and establish connection with the specified communication destination candidate B.

(Example Configuration of Communication System and Related Information)

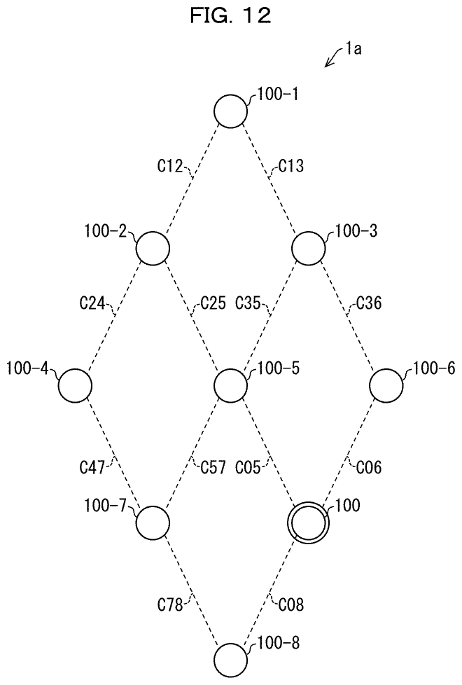

Subsequently, an example configuration of a communication system according to the third example embodiment and an example of related information managed by the communication apparatus 100 will be described with reference to FIG. 12. FIG. 12 is a diagram illustrating an example configuration of a communication system 1a according to the third example embodiment. In the example illustrated in FIG. 12, the communication system 1a includes not only the communication apparatus 100 according to the third example embodiment but also other communication apparatuses 100-1 to 100-8. These communication apparatuses 100-1 to 100-8 each have, for example, a configuration similar to the configuration of the communication apparatus 100 according to the third example embodiment.

Furthermore, in FIG. 12, a dotted line indicates an established connection. In FIG. 12, a reference sign “Cxy” (x and y are numerals) indicates a connection established between a communication apparatus 100-x and a communication apparatus 100-y. For example, C12 indicates a connection established between the communication apparatus 100-1 and the communication apparatus 100-2.

As illustrated in FIG. 12, the communication apparatuses included in the communication system 1a constitute a mesh network having a communication path that is spread in net form.

In FIG. 12, any of the communication apparatuses 100 and 100-1 to 100-8 may be configured to function as an edge terminal. Alternatively, the communication system 1a may be configured to include not only the communication apparatuses illustrated in FIG. 12 but also at least one edge terminal connected to any of the communication apparatuses.

(Related Information)

The acquisition unit 131 included in the communication apparatus 100 acquires, for example, related information pertaining to an apparatus of the communication destination of the communication apparatus 100. The storage management unit 133 included in the communication apparatus 100 stores, in the storage unit 150, the related information acquired by the acquisition unit 131, and manages the related information. Note here that the communication destination of the communication apparatus 100 at least includes at least one selected from the group consisting of the following: at least one connection destination candidate specified by the communication management unit 132; and at least one connection destination with connection established by the communication management unit 132.

Furthermore, the storage management unit 133 can be configured to also store, in the storage unit 150, related information related to the communication apparatus 100, and manage the related information.

One of the communication apparatuses included in the communication system according to the third example embodiment is hereinafter referred to as a communication apparatus A. The following description discusses details of related information of the communication apparatus A in a case where communication apparatuses B, C, and D are present as the communication destination of the communication apparatus A. The communication apparatuses A, B, C, and D are each, for example, any of the communication apparatuses 100 and 100-1 to 100-8.

First, the related information of the communication apparatus A includes at least one selected from the group consisting of the following:
positional information of the communication apparatus A;
a load state of the communication apparatus A;
the number of established connections in which the communication apparatus A is involved;
the number of connection destination candidates specified by scanning in which the communication apparatus A is involved;
a connection state of connection in which the communication apparatus A is involved; and
a hop count from the communication apparatus A to a connection reference point.

Note here that a specific example of the positional information of the communication apparatus A does not limit the second example embodiment. For example, the positional information may be coordinate information assigned by a predetermined position specifying system such as a GPS, positional identification information such as an address assigned in advance to a target communication region, or information indicative of a direction of the communication apparatus A as viewed from a communication apparatus in a surrounding area of the communication apparatus A.

A specific indicator of the load state of the communication apparatus A does not limit the third example embodiment. For example, the specific indicator may be information indicative of an operation rate of a processor such as a control unit included in the communication apparatus A, or information indicative of an operation rate of a specific task carried out by the processor such as the control unit included in the communication apparatus A.

The connection in which the communication apparatus A is involved includes at least one selected from the group consisting of the following: a connection to/from the communication apparatus A; and a connection through the communication apparatus A. Thus, in the case of the example described above, the connection in which the communication apparatus A is involved includes at least one selected from the group consisting of the following: a connection between the communication apparatus A and the communication apparatus B; a connection between the communication apparatus A and the communication apparatus C; and a connection between the communication apparatus A and the communication apparatus D.

The connection state of connection in which a communication destination A described earlier is involved includes at least one selected from the group consisting of the following:
a line quality of the connection in which the communication apparatus A is involved; and
the number of times of disconnection in the connection in which the communication apparatus A is involved.

Note here that a specific indicator pertaining to the line quality of the connection in which the communication apparatus A is involved does not limit the third example embodiment. For example, the specific indicator includes any of indicators such as a delay in communication due to the connection and a rate of loss of information in communication due to the connection.

Note also that a specific indicator pertaining to the number of times of disconnection in the connection in which the communication apparatus A is involved does not limit the third example embodiment. For example, the specific indicator includes an indicator pertaining to the number of times of disconnection per unit time in communication by the connection.

The related information of the communication apparatus A may be configured to include the following:
information pertaining to an influence of an environment on the connection in which the communication apparatus A is involved.

Note here that for example, the information pertaining to the influence of the environment on the connection in which the communication apparatus A is involved includes at least one selected from the group consisting of the following:
a degree of influence of sunlight on the connection between the communication apparatus A and the communication apparatus B;
a degree of influence of sunlight on the connection between the communication apparatus A and the communication apparatus C; and
a degree of influence of sunlight on the connection between the communication apparatus A and the communication apparatus D.

A degree of influence of sunlight on a certain connection can be expressed by, for example, an angle in a solar direction with reference to a direction along the certain connection. For example, in a case where an angle between the direction along the certain connection and the solar direction is close to 90°, information pertaining to the influence indicates that the influence of sunlight on the certain connection is relatively small. In contrast, for example, in a case where the angle between the direction along the certain connection and the solar direction is close to 0°, the information pertaining to the influence indicates that the influence of sunlight on the certain connection is relatively large.

The information pertaining to the influence of the environment on the connection in which the communication apparatus A is involved may be configured to include, as another example, information indicative of an influence of reflection and/or absorption on a directional communication medium used by a communication unit of the communication apparatus A. For example, in a case where the directional communication medium used by the communication unit of the communication apparatus A propagates through air, the information pertaining to the influence of the environment on the connection in which the communication apparatus A is involved may be configured to include information such as transparency of the air and information such as a building near a propagation path.

(Example Process Carried Out by Communication Apparatus)

Specific example processes carried out by a communication apparatus related to the communication system 1a will be described below. Note that these example processes can also be used in combination with each other, and an example process obtained after the combination is also included in the third example embodiment.

(Example Process 1-1 Carried Out by Communication Apparatus)

The following description discusses an example process 1-1 carried out by a communication apparatus. As described earlier, the acquisition unit 131 included in the communication apparatus 100 acquires, for example, related information pertaining to an apparatus of the communication destination of the communication apparatus 100. The storage management unit 133 included in the communication apparatus 100 stores, in the storage unit 150, the related information acquired by the acquisition unit 131, and manages the related information.

Assume, for example, a case where the communication apparatuses 100-5, 100-6, and 100-8 are present as the communication destination of the communication apparatus 100 in the communication system 1a as illustrated in FIG. 12.

For example, the communication apparatuses 100-5, 100-6, and 100-8 each provide the communication apparatus 100 with related information related to an apparatus. In this case, the acquisition unit 131 of the communication apparatus 100 acquires, from the respective communication apparatuses 100-5, 100-6, and 100-8, the following:
related information RI 100-5 related to the communication apparatus 100-5;
related information RI 100-6 related to the communication apparatus 100-6; and
related information RI 100-8 related to the communication apparatus 100-8.
   The acquisition unit 131 stores these pieces of related information in the storage unit 150 and manages the pieces of related information.

As another example, the control unit 130 of the communication apparatus 100 may be configured to function as a provision means that provides, via the first communication unit 110 to a communication destination different from at least one communication destination, related information related to the at least one communication destination, the related information having been acquired by the acquisition unit 131.

For example, the control unit 130 of the communication apparatus 100 may be configured such that the acquisition unit 131 provides the communication apparatus 100-8, which is a communication destination different from the communication apparatus 100-5 and the communication apparatus 100-6, with the related information RI 100-5 and the related information RI 100-6, which have been acquired from the communication apparatus 100-5 and the communication apparatus 100-6, respectively.

Note here that the related information RI 100-5 related to the communication apparatus 100-5 may be configured to include related information related to a communication destination of the communication apparatus 100-5. In other words, the communication apparatus 100-5 may be configured to acquire, in advance, pieces of related information related to the communication apparatuses 100-2, 100-3, and 100-7, each of which is the communication destination of the communication apparatus 100-5, and include these pieces of information in related information related to the communication apparatus 100-5.

In the case of such a configuration, the acquisition unit 131 of the communication apparatus 100 can acquire, via the related information RI 100-5 related to the communication apparatus 100-5, the following:
related information RI 100-2 related to the communication apparatus 100-2;
related information RI 100-3 related to the communication apparatus 100-3; and
related information RI 100-7 related to the communication apparatus 100-7.

Similarly, the acquisition unit 131 of the communication apparatus 100 can acquire, via the related information RI 100-6 related to the communication apparatus 100-6, the following:
the related information RI 100-3 related to the communication apparatus 100-3.

The acquisition unit 131 of the communication apparatus 100 can acquire, via the related information RI 100-8 related to the communication apparatus 100-8, the following:
the related information RI 100-7 related to the communication apparatus 100-7.

Furthermore, the related information RI 100-7 related to the communication apparatus 100-7 may be configured to acquire pieces of related information related to the communication apparatus 100-4, which is a communication destination of the communication apparatus 100-7, and include these pieces of information in related information related to the communication apparatus 100-7.

Similarly, the related information RI 100-3 related to the communication apparatus 100-3 may be configured to acquire pieces of related information related to the communication apparatus 100-1, which is a communication destination of the communication apparatus 100-3, and include these pieces of information in related information related to the communication apparatus 100-3.

In the case of such a configuration, the acquisition unit 131 of the communication apparatus 100 can acquire the related information RI 100-1 to the related information RI 100-8 pertaining to all the other communication apparatuses 100-1 to 100-8 belonging to the communication system 1a.

As described above, in a case where related information related to a certain communication apparatus is included in related information related to another communication apparatus, each communication apparatus can acquire wide-area information pertaining to the communication system 1a.

Thus, use of such wide-area information makes it possible to carry out wide-area control pertaining to the communication system 1a by control carried out by each communication apparatus.

(Example Process 1-2 Carried Out by Communication Apparatus)

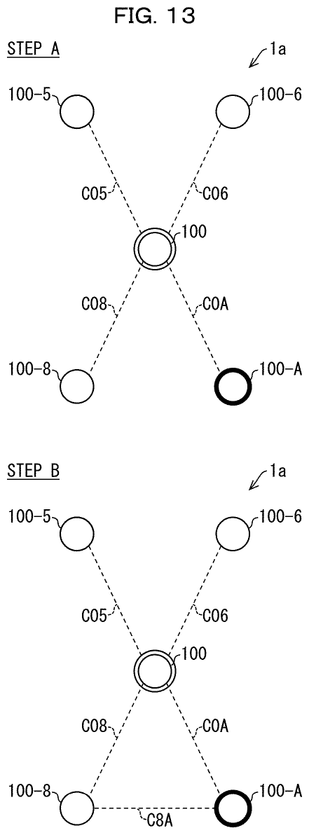

Subsequently, an example process 1-2 carried out by a communication apparatus will be described. FIG. 13 is a diagram illustrating the communication system 1a according to the example process 1-2. The example process 1-2 is an example process in a case where a new communication apparatus 100-A is connected to the communication system 1a. Note here that the new communication apparatus 100-A has, for example, a configuration similar to the configuration of the communication apparatus 100.

(Step-A)

First, in a step A, the communication apparatus 100 establishes connection with the communication apparatus 100-A. Since a procedure for establishing the connection has been described earlier, a description thereof is omitted here. Note that scanning from the communication apparatus 100 may trigger establishment of the connection. Alternatively, scanning from the communication apparatus 100-A may trigger establishment of the connection.

In this step A, via the first communication unit 110, the control unit 130 of the communication apparatus 100 provides the communication apparatus 100-A with the following:
related information RI 100 related to the communication apparatus 100;
the related information RI 100-5 related to the communication apparatus 100-5;
the related information RI 100-6 related to the communication apparatus 100-6; and
the related information RI 100-8 related to the communication apparatus 100-8.

(Step-B)

Subsequently, in a step B, a control unit included in the communication apparatus 100-A according to the third example embodiment refers to the related the related information RI 100, the related information RI 100-5, the related information RI 100-6, and the related information RI 100-8 each having been received from the communication apparatus 100, and functions as a judgment means that judges the following:
whether communication with a communication apparatus different from the communication apparatus 100 serving as a provider of the related information will be carried out.

For example, the control unit included in the communication apparatus 100-A refers to positional information of the communication apparatus 100-8, the positional information being included in the related information RI 100 or the related information RI 100-8, and judges that the communication apparatus 100-A is located relatively close to the communication apparatus 100-8. The control unit included in the communication apparatus 100-A determines that communication with the communication apparatus 100-8 will be carried out. After making such a determination, for example, the communication apparatus 100-A transmits, to the communication apparatus 100-8, a scanning beam that precedes establishment of connection with the communication apparatus 100-8.

Thus, the communication apparatus according to the example process 1-2 refers to related information received from another communication apparatus, and determines whether communication with at least one communication apparatus will be carried out. This makes it possible to configure, in accordance with the related information, the communication system 1a that has an adaptive network configuration.

(Example Process 1-3 Carried Out by Communication Apparatus)

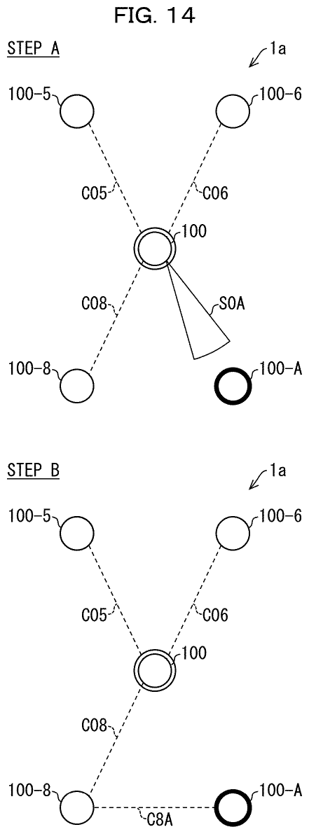

Subsequently, an example process 1-3 carried out by a communication apparatus will be described. FIG. 14 is a diagram illustrating the communication system 1a according to the example process 1-3. The example process 1-3 is an example process in a case where a new communication apparatus 100-A is connected to the communication system 1a. Note here that the new communication apparatus 100-A has, for example, a configuration similar to the configuration of the communication apparatus 100.

(Step-A)

First, in a step A, the communication apparatus 100 transmits a scanning beam S0A in a direction in which the communication apparatus 100-A is present. Note here that the scanning beam S0A includes the following:
the related information RI 100 related to the communication apparatus 100.

(Step-B)

Subsequently, in a step B, the communication apparatus 100-A acquires, from the scanning beam S0A received from the communication apparatus, the following:
the related information RI 100 related to the communication apparatus 100.

A control unit of the communication apparatus 100-A refers to the related information RI 100 and functions as a judgment means that judges the following:
whether connection with the communication apparatus 100 will be established; and
whether communication with a communication apparatus different from the communication apparatus 100 will be carried out.

For example, the control unit of the communication apparatus 100-A refers to the related information RI 100-8 related to the communication apparatus 100-8, the related information RI 100-8 being included in the related information RI 100. The control unit of the communication apparatus 100-A judges, in accordance with the positional information included in the related information RI 100-8, that the communication apparatus 100A is located relatively close to the communication apparatus 100-8. The control unit included in the communication apparatus 100-A determines that communication with the communication apparatus 100-8 will be carried out. After making such a determination, for example, the communication apparatus 100-A transmits, to the communication apparatus 100-8, a scanning beam that precedes establishment of connection with the communication apparatus 100-8.

Thus, the communication apparatus according to the example process 1-3 refers to related information included in a scanning beam received from another communication apparatus, and determines whether communication with at least one communication apparatus will be carried out. This makes it possible to quickly configure, in accordance with the related information, the communication system 1a that has an adaptive network configuration.

(Example Process 2-1 Carried Out by Communication Apparatus)

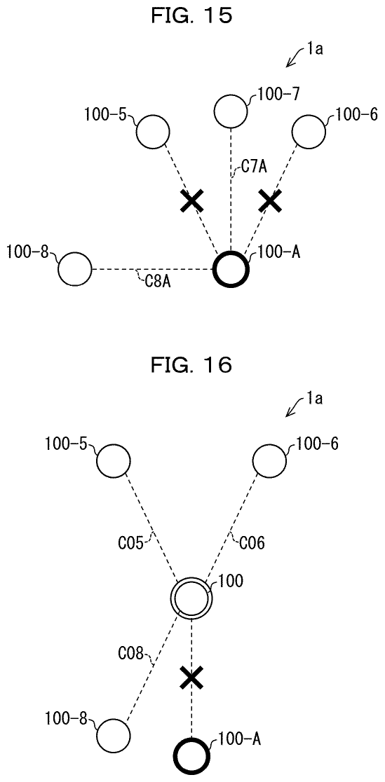

Subsequently, an example process 2-1 carried out by a communication apparatus will be described. FIG. 15 is a diagram illustrating the communication system 1a according to the example process 2-1. The example process 2-1 is an example process in a case where a new communication apparatus 100-A is connected to the communication system 1a. Note here that the new communication apparatus 100-A has, for example, a configuration similar to the configuration of the communication apparatus 100.

In the example process 2-1, a control unit of the communication apparatus 100-A establishes connection with the communication apparatus 100-8. As a first-stage judgment process, the control unit of the communication apparatus 100-A selects a communication destination candidate so that an angle between the communication destination candidate and the communication apparatus 100-8 as viewed from the communication apparatus 100-A is not less than a predetermined angle.

Note here that a specific determination process carried out by the control unit of the communication apparatus 100-A does not limit the third example embodiment. For example, the control unit of the communication apparatus 100-A can be configured to acquire related information related to the communication destination candidate, and carry out the above-described selection with reference to the acquired related information. In the example illustrated in FIG. 15, the communication apparatuses 100-5, 100-6, and 100-7 are selected as the first-stage judgment process.

As a second-stage judgment process, the control unit of the communication apparatus 100-A selects the communication apparatus 100-7 from among the communication apparatuses 100-5, 100-6, and 100-7 so that an angle between the communication apparatuses as viewed from the communication apparatus 100-A is not less than a predetermined angle.

Note here that a specific determination process carried out by the control unit of the communication apparatus 100-A does not limit the third example embodiment. For example, the control unit of the communication apparatus 100-A can be configured to acquire related information related to each of the communication apparatuses 100-5, 100-6, and 100-7, and carry out the above-described selection with reference to the acquired related information.

Note that in the above example, a specific value of the predetermined angle does not limit the third example embodiment. For example, the predetermined angle can be set to approximately 30° to 45°.

The example process 2-1 has taken, as an example, a case where the control unit of the communication apparatus 100-A carries out the above-described selection with reference to related information. Note, however, that the present invention is not limited to the example. For example, the control unit of the communication apparatus 100-A may be configured to specify positional information of the communication apparatus 100-8 and the communication apparatuses 100-5, 100-6, and 100-7 by a scanning process with respect to the communication apparatus 100-8 and a scanning process with respect to the communication apparatuses 100-5, 100-6, and 100-7, and carry out the above-described selection with reference to the specified positional information.

More specifically, the control unit of the communication apparatus 100-A may be configured to refer to the following:
a scanning beam or response beam from the communication apparatus 100-8;
a scanning beam or a response beam from the communication apparatus 100-5;
a scanning beam or response beam from the communication apparatus 100-6; and
a scanning beam or response beam from the communication apparatus 100-7,
   specify positions of these communication apparatuses, and carry out the above-described selection with reference to the specified positions.

A directional communication medium commonly has the following aspects. Specifically, the directional communication medium, which has a large frequency, can be expected to achieve large-capacity and low-delay communication. In contrast, the directional communication medium is susceptible to influence such as shielding and/or disturbance due to its directionality. Furthermore, in a case where a plurality of communication apparatuses are present in similar directions as viewed from a certain communication apparatus, it is considered that influence of disturbance spreads to each of the plurality of communication apparatuses. For example, it is considered that influence of sunlight occurs simultaneously on communication with these plurality of communication apparatuses during a specific time period.

According to the example process 2-1, a communication destination is selected so that an angle between a plurality of communication destinations as viewed from a certain communication apparatus is not less than a predetermined angle. This brings about an effect of making it possible to minimize influence of disturbance on the communication system 1a.

(Example Process 2-2 Carried Out by Communication Apparatus)

Subsequently, an example process 2-2 carried out by a communication apparatus will be described. FIG. 16 is a diagram illustrating the communication system 1a according to the example process 2-2. The example process 2-2 is an example process in a case where a new communication apparatus 100-A is connected to the communication system 1a. Note here that the new communication apparatus 100-A has, for example, a configuration similar to the configuration of the communication apparatus 100.

In the example process 2-2, the control unit 130 of the communication apparatus 100 establishes connection between the communication apparatuses 100-5, 100-6, and 100-8. Assume, in this situation, that the communication apparatus 100 has received a scanning beam from the communication apparatus 100-A. The control unit 130 of the communication apparatus 100 uses the scanning beam to specify positional information of the communication apparatus 100-A. For example, the control unit 130 of the communication apparatus 100 specifies an angle between the communication apparatus 100-8 and the communication apparatus 100-A as viewed from the communication apparatus 100.

In the example process 2-2, in a case where a communication destination candidate is present in a range of predetermined angles from a connected communication destination, the control unit 130 of the communication apparatus 100 functions as a determination means that lowers priority of the communication destination candidate.

For example, since the communication apparatus 100-A is present as the communication destination candidate in a range of predetermined angles from the communication apparatus 100-8 with established connection, the control unit 130 of the communication apparatus 100 lowers priority of the communication apparatus 100-A.

For example, the control unit 130 of the communication apparatus 100 determines that connection with the communication apparatus 100-A with reduced priority will not be carried out.

Note that in the above example, a specific value of the predetermined angle does not limit the third example embodiment. For example, the predetermined angle can be set to approximately 30° to 45°.

A directional communication medium commonly has the following aspects. Specifically, the directional communication medium, which has a large frequency, can be expected to achieve large-capacity and low-delay communication. In contrast, the directional communication medium is susceptible to influence such as shielding and/or disturbance due to its directionality. Furthermore, in a case where a plurality of communication apparatuses are present in similar directions as viewed from a certain communication apparatus, it is considered that influence of disturbance spreads to each of the plurality of communication apparatuses. For example, it is considered that influence of sunlight occurs simultaneously on communication with these plurality of communication apparatuses during a specific time period.

According to the example process 2-2, in a case where a communication destination candidate is present in a range of predetermined angles from a connected communication destination, priority of the communication destination candidate is lowered. This brings about an effect of making it possible to minimize influence of disturbance on the communication system 1a.

(Example Process 2-3 Carried Out by Communication Apparatus)

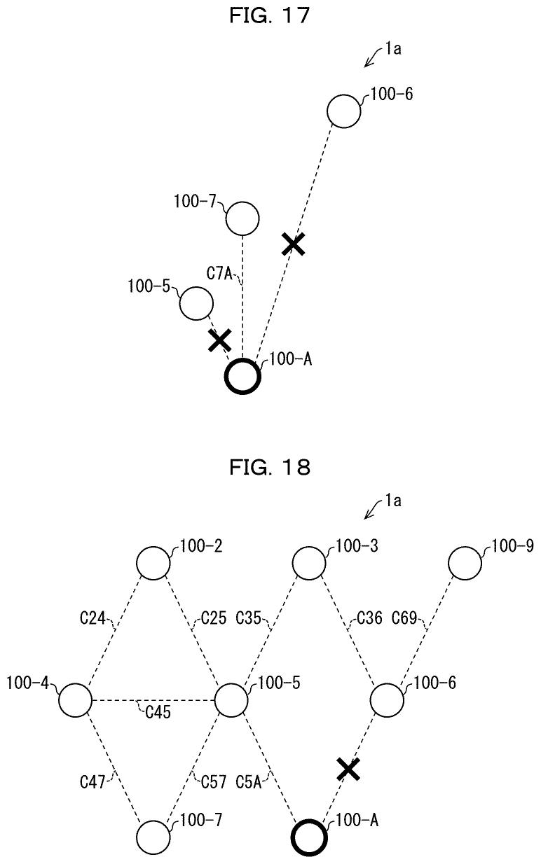

Subsequently, an example process 2-3 carried out by a communication apparatus will be described. FIG. 17 is a diagram illustrating the communication system 1a according to the example process 2-3. The example process 2-3 is an example process in a case where a new communication apparatus 100-A is connected to the communication system 1a. Note here that the new communication apparatus 100-A has, for example, a configuration similar to the configuration of the communication apparatus 100.

In the example process 2-3, the control unit 130 of the communication apparatus 100-A provides the positional information of the communication apparatus 100-A to the communication apparatuses 100-5, 100-6, and 100-7. For example, the control unit 130 of the communication apparatus 100-A transmits, to the communication apparatuses 100-5, 100-6, and 100-7, a scanning beam including the positional information of the communication apparatus 100-A.

A control unit of the communication apparatus 100-5, a control unit of the communication apparatus 100-6, and a control unit of the communication apparatus 100-7 each determine, with reference to the positional information of the communication apparatus 100-A, which is a communication destination candidate, whether communication with the communication apparatus 100-A will be established.

For example, with reference to the positional information of the communication apparatus 100-A, which is the communication destination candidate, the control unit of the communication apparatus 100-5, the control unit of the communication apparatus 100-6, and the control unit of the communication apparatus 100-7 each determine, in a case where a distance from the communication apparatus 100-A is in a predetermined range, that communication with the communication apparatus 100-A will be established.

In other words, the communication apparatuses 100-5, 100-6, and 100-7 each may function as a determination means that determines, with reference to positional information of a plurality of communication destination candidates, with which of the communication destination candidates connection will be established. Alternatively, the communication apparatuses 100-5, 100-6, and 100-7 each may function as a determination means that with reference to positional information of a plurality of communication destination candidates, determines, as the at least one communication destination, at least one communication destination candidate whose distance from the communication apparatuses 100-5, 100-6, and 100-7 is in the predetermined range.

For example, with reference to the positional information of the communication apparatus 100-A, the control unit of the communication apparatus 100-5 judges that a distance between the communication apparatus 100-5 and the communication apparatus 100-A is not included in the predetermined range and is too short, and determines that communication with the communication apparatus 100-A will not be established.

Furthermore, for example, with reference to the positional information of the communication apparatus 100-A, the control unit of the communication apparatus 100-6 judges that a distance between the communication apparatus 100-6 and the communication apparatus 100-A is not included in the predetermined range and is too long, and determines that communication with the communication apparatus 100-A will not be established.

Moreover, for example, with reference to the positional information of the communication apparatus 100-A, the control unit of the communication apparatus 100-7 judges that a distance between the communication apparatus 100-7 and the communication apparatus 100-A is included in the predetermined range, and determines that communication with the communication apparatus 100-A will be established. The control unit of the communication apparatus 100-7 establishes connection with the communication apparatus 100-A.

Note that in the above description, a specific example of the predetermined range regarding the distance does not limit the third example embodiment. For example, the predetermined range can be determined in accordance with, for example, a characteristic of a directional communication medium used by each of the communication apparatuses. For example, the predetermined range can be set to a range from 50 m to 500 m. The control unit of the communication apparatus 100-5, the control unit of the communication apparatus 100-6, and the control unit of the communication apparatus 100-7 may be configured to acquire information indicative of influence of reflection and/or absorption on the directional communication medium, and adaptively change the predetermined range with reference to the acquired information. For example, the control unit of the communication apparatus 100-5, the control unit of the communication apparatus 100-6, and the control unit of the communication apparatus 100-7 may be configured to, in a case where the directional communication medium propagates through air, acquire information such as transparency of the air and information such as a building near a propagation path, and adaptively change the predetermined range in accordance with these pieces of information.

Thus, according to the example process 2-3, a communication apparatus refers to positional information of a plurality of communication destination candidates and determines with which of the communication destination candidates connection will be established. Alternatively, with reference to positional information of a plurality of communication destination candidates, a communication apparatus determines, as the at least one communication destination, at least one communication destination candidate whose distance from the communication apparatus is in a predetermined range.

Thus, the example process 2-3 makes it possible to configure a communication system including a communication apparatus that is suitably disposed.

(Example Process 3-1 Carried Out by Communication Apparatus)

Subsequently, an example process 3-1 carried out by a communication apparatus will be described. FIG. 18 is a diagram illustrating the communication system 1a according to the example process 3-1. The example process 3-1 is an example process in a case where a new communication apparatus 100-A is connected to the communication system 1a. Note here that the new communication apparatus 100-A has, for example, a configuration similar to the configuration of the communication apparatus 100.

In the example process 3-1, a control unit of the communication apparatus 100-A functions, as an acquisition means that acquires, from the communication apparatus 100-5 and the communication apparatus 100-6, which are communication destination candidates,
the related information RI 100-5 related to the communication apparatus 100-5, and
the related information RI 100-6 related to the communication apparatus 100-6, respectively.
   The control unit of the communication apparatus 100-A refers to the following numbers included in the related information RI 100-5 and the related information RI 100-6, respectively:
the number of established connections in which the communication apparatus 100-5 is involved; and
the number of established connections in which the communication apparatus 100-6 is involved.

The control unit of the communication apparatus 100-A functions as a determination means that determines, as the connection destination, a communication destination that is one of the communication apparatus 100-5 and the communication apparatus 100-6 and that has more established connections.

For example, in the case of the example illustrated in FIG. 18, the communication apparatus 100-5 has a total of four established connections, which are connections C57, C45, C25, and C35, except for the connection with the communication apparatus 100-A. The communication apparatus 100-6 has a total of two established connections C36 and C69. Thus, the control unit of the communication apparatus 100-A determines the communication apparatus 100-5 as the connection destination and establishes connection. The control unit of the communication apparatus 100-A neither determines the communication apparatus 100-6 as the connection destination nor establishes connection.

The control unit of the communication apparatus 100-A may be configured to refer to the following:
the related information RI 100-5 related to the communication apparatus 100-5; and
the related information RI 100-6 related to the communication apparatus 100-6,
   and determine, as the connection destination, a communication destination that has more connections which have been established and which are in use.

Note that a specific method in which the control unit of the communication apparatus 100-A acquires the above pieces of related information does not limit the third example embodiment. For example, the control unit of the communication apparatus 100-A can be configured to refer to a scanning beam or response beam received from a corresponding one of the communication apparatus 100-5 and the communication apparatus 100-6, which are the communication destination candidates, and acquire related information included in the scanning beam or response beam.

A communication apparatus that has a larger number of established connections and that has more connections in use tends to be a highly reliable communication apparatus. According to the example process 3-1, the communication apparatus 100-A can establish communication with a more highly reliable communication apparatus. This makes it possible to configure the communication system 1a that is more highly reliable.

(Example Process 3-2 Carried Out by Communication Apparatus)

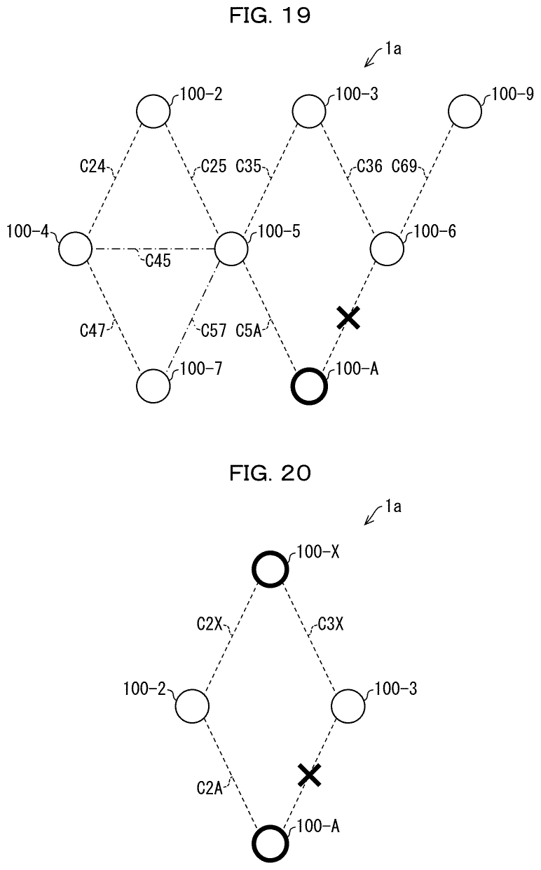

Subsequently, an example process 3-2 carried out by a communication apparatus will be described. FIG. 19 is a diagram illustrating the communication system 1a according to the example process 3-2. The example process 3-2 is an example process in a case where a new communication apparatus 100-A is connected to the communication system 1a. Note here that the new communication apparatus 100-A has, for example, a configuration similar to the configuration of the communication apparatus 100.

In the example process 3-2, a control unit of the communication apparatus 100-A functions, as an acquisition means that acquires, from the communication apparatus 100-5 and the communication apparatus 100-6, which are communication destination candidates,
the related information RI 100-5 related to the communication apparatus 100-5, and
the related information RI 100-6 related to the communication apparatus 100-6, respectively.
   The control unit of the communication apparatus 100-A refers to the following included in the related information RI 100-5:
the number of established connections in which the communication apparatus 100-5 is involved;
the number of connection destination candidates specified by scanning in which the communication apparatus 100-5 is involved; and
a connection state of connection in which the communication apparatus 100-5 is involved, and
   specifies the following numbers possessed by the communication apparatus 100-5:
the number of unused connections among the established connections; and
the number of connection destination candidates with unestablished connection among the connection destination candidates specified by scanning.

Similarly, the control unit of the communication apparatus 100-A refers to the following included in the related information RI 100-6:
the number of established connections in which the communication apparatus 100-6 is involved;
the number of connection destination candidates specified by scanning in which the communication apparatus 100-6 is involved; and
a connection state of connection in which the communication apparatus 100-6 is involved, and specifies the following numbers possessed by the communication apparatus 100-6:
the number of unused connections among the established connections; and
the number of connection destination candidates with unestablished connection among the connection destination candidates specified by scanning.

The control unit of the communication apparatus 100-A determines, as the connection destination, a communication destination that has a larger number of the following:
unused connections among the established connections; or connection destination candidates with unestablished connection among the connection destination candidates specified by scanning.

For example, in the example illustrated in FIG. 19, an unused connection among the established connections is represented by dotted and dashed lines. In the example illustrated in FIG. 19, the communication apparatus 100-5 has a total of two unused connections C57 and C54 among the established connections. In contrast, the communication apparatus 100-6 has no unused connection among the established connections.

Thus, the control unit of the communication apparatus 100-A determines the communication apparatus 100-5 as the communication destination and establishes connection. The control unit of the communication apparatus 100-A neither determines the communication apparatus 100-6 as the connection destination nor establishes connection.

Note that a specific method in which the control unit of the communication apparatus 100-A acquires the above pieces of related information does not limit the third example embodiment. For example, the control unit of the communication apparatus 100-A can be configured to refer to a scanning beam or response beam received from a corresponding one of the communication apparatus 100-5 and the communication apparatus 100-6, which are the communication destination candidates, and acquire related information included in the scanning beam or response beam.

The control unit of the communication apparatus 100-A may be configured to, in a case where the number of established connections in which the communication apparatus 100-5 is involved or the number of used connections among the established connections reaches a value obtained by subtracting 1 from the maximum number of connections that a communication means of the communication apparatus 100-5 can establish, function as a connection establishment means for carrying out a process for
carrying out no further connection establishment, or
carrying out further connection and causing a connected connection to be in an unused state.

Similarly, the control unit of the communication apparatus 100-A may be configured to, in a case where the number of established connections in which the communication apparatus 100-6 is involved or the number of used connections among the established connections reaches a value obtained by subtracting 1 from the maximum number of connections that a communication means of the communication apparatus 100-6 can establish, function as a connection establishment means for carrying out a process for
carrying out no further connection establishment, or
carrying out further connection and causing a connected connection to be in an unused state.

The control unit of the communication apparatus 100-5 or 100-6 may be configured to, in a case where the number of established connections or the number of used connections among the established connections reaches a value obtained by subtracting 1 from the maximum number of connections that a communication unit included in the communication apparatus 100-5 or 100-6 can establish, function as a connection establishment means for carrying out a process for
carrying out no further connection establishment, or
carrying out further connection and causing a connected connection to be in an unused state.

A communication apparatus that has a larger number of established connections commonly tends to be a highly reliable communication apparatus. In contrast, from the viewpoint of effective use of a connection path, it is advantageous to establish connection with a communication apparatus that has many unused connections among the established connections.

In addition, from a similar viewpoint, it is advantageous to establish connection with a communication destination that has more connection destination candidates with unestablished connection among the connection destination candidates specified by scanning.

According to the example process 3-2, the communication apparatus 100-A determines, as the connection destination, a communication destination that has more unused connections among the established connections or more connection destination candidates with unestablished connection among the connection destination candidates specified by scanning. This makes it possible to configure the communication system 1a which is highly reliable and in which a communication path is effectively used.

In the example process 3-2, the communication system 1a in which unused connections are intentionally created can also be configured as described above. Thus, intentional creation of unused connections makes it possible to configure the communication system 1a that can also flexibly deal with a case where a new connection with high urgency occurs.

(Example Process 4-1 Carried Out by Communication Apparatus)

Subsequently, an example process 4-1 carried out by a communication apparatus will be described. FIG. 20 is a diagram illustrating the communication system 1a according to the example process 4-1. The example process 4-1 is an example process in a case where a new communication apparatus 100-A is connected to the communication system 1a. Note here that the new communication apparatus 100-A has, for example, a configuration similar to the configuration of the communication apparatus 100.

In the example process 4-1, a case where use information described later indicates a first purpose will be mainly described. A case where the use information indicates a second purpose will be described in an example process 4-2 carried out by a communication apparatus.

In the example process 4-1, a control unit of the communication apparatus 100-A functions as a provision means that provides use information pertaining to a purpose of connection to the communication apparatus 100-2 and the communication apparatus 100-3, which are communication destination candidates.

Note here that the use information includes information pertaining to whether the purpose of connection is a first purpose or a second purpose different from the first purpose.

Note here that specific examples of the first purpose and the second purpose do not limit the second example embodiment. For example, the first purpose refers to a case where the connection is used for an access link, and the second purpose refers to a case where the connection is used for a backbone link.

Note here that the access link mainly refers to a connection path for use in data exchange between edge terminals included in the communication system 1a. Note also that the backbone link mainly refers to a connection path for use in data exchange between communication apparatuses included in the communication system 1a and different from an edge terminal. Even the backbone link sometimes functions as the access link depending on a situation.

Upon receiving the use information from the communication apparatus 100-A, a control unit of the communication apparatus 100-2 and a control unit of the communication apparatus 100-3 respectively transmit, to the communication apparatus 100-A, the following as responses to the use information:
the related information RI 100-2 related to the communication apparatus 100-2; and
the related information RI 100-3 related to the communication apparatus 100-3.
   The control unit of the communication apparatus 100-A also functions as an acquisition means that acquires the related information.

Note here that the related information provided to the communication apparatus 100-A may vary in content in accordance with the use information. For example, in a case where the use information indicates the first purpose, the control unit of the communication apparatus 100-2 and the control unit of the communication apparatus 100-3 may be configured to provide the communication apparatus 100-A with the related information, which is
a connection state of connection in which the communication apparatus 100-2 is involved, and
a connection state of connection in which the communication apparatus 100-3 is involved, respectively,
   so that the control unit of the communication apparatus 100-A acquires these pieces of information.

Note here that the connection state of connection in which the communication apparatus 100-2 is involved includes at least one selected from the group consisting of the following:
a line quality of the connection in which the communication apparatus 100-2 is involved;
the number of times of disconnection in the connection in which the communication apparatus 100-2 is involved; and
delay time in the connection in which the communication apparatus 100-2 is involved.
   Note also that the connection state of connection in which the communication apparatus 100-3 is involved includes at least one selected from the group consisting of the following:
a line quality of the connection in which the communication apparatus 100-3 is involved;
the number of times of disconnection in the connection in which the communication apparatus 100-3 is involved; and
delay time in the connection in which the communication apparatus 100-3 is involved.

The control unit of the communication apparatus 100-A also functions as a determination means that determines connection/disconnection to/from the communication apparatus 100-2 and connection/disconnection to/from the communication apparatus 100-3 with reference to the following:
the related information RI 100-2 related to the communication apparatus 100-2; and
the related information RI 100-3 related to the communication apparatus 100-3.

For example, the control unit of the communication apparatus 100-A determines, in a case where the purpose of connection is the first purpose, establishment of connection with one of the communication apparatus 100-2 and the communication apparatus 100-3 which one has a better line quality, a smaller number of times of disconnection, and a shorter delay time. For example, in the example illustrated in FIG. 20, the control unit of the communication apparatus 100-A judges that a connection in which the communication apparatus 100-2 is involved has a better line quality, and establishes a connection C2A with the communication apparatus 100-2 while establishing no connection with the communication apparatus 100-3.

Note that a specific method in which the control unit of the communication apparatus 100-A acquires the above pieces of related information does not limit the third example embodiment. For example, the control unit of the communication apparatus 100-A can be configured to refer to a scanning beam or response beam received from a corresponding one of the communication apparatus 100-2 and the communication apparatus 100-3, which are the communication destination candidates, and acquire related information included in the scanning beam or response beam.

A requirement required for a communication path commonly may vary in accordance with a purpose of the communication path. According to the example process 4-1, the control unit of the communication apparatus 100-A is configured to:
provide, to at least one communication destination, use information pertaining to a purpose of connection;
from the at least one communication destination, acquire, as a response to the use information, related information related to the at least one communication destination; and
determine connection/disconnection to/from the at least one communication destination with reference to the related information related to the at least one communication destination.
   This makes it possible to configure a suitable communication path in accordance with an objective of connection.

In the example process 4-1, the communication apparatus 100-A establishes communication with a communication apparatus with a relatively good line state among the communication destination candidates. This makes it possible to configure the communication system 1a with a suitable communication state.

(Example Process 4-2 Carried Out by Communication Apparatus)

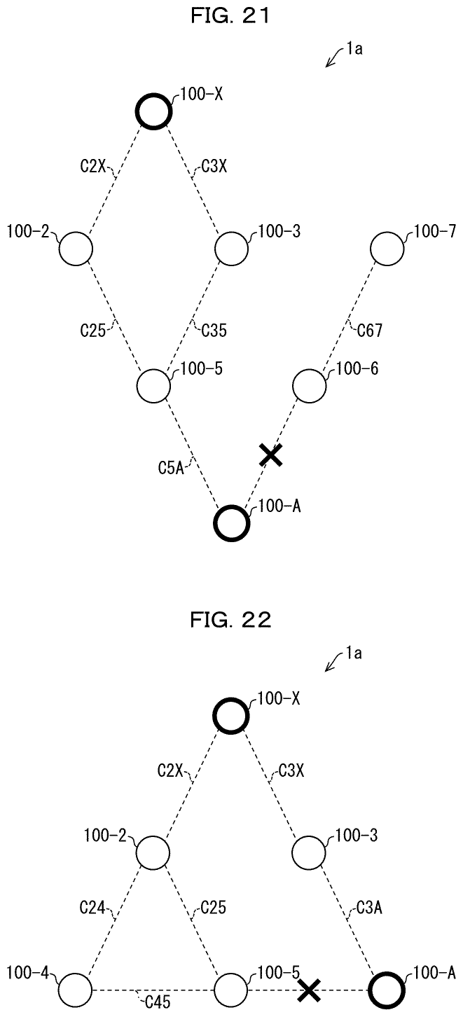

Subsequently, the example process 4-2 carried out by the communication apparatus will be described. FIG. 21 is a diagram illustrating the communication system 1a according to the example process 4-2. The example process 4-2 is an example process in a case where a new communication apparatus 100-A is connected to the communication system 1a. Note here that the new communication apparatus 100-A has, for example, a configuration similar to the configuration of the communication apparatus 100.

Furthermore, in the example process 4-2, a case will be mainly described where the use information described in the example process 4-1 carried out by the communication apparatus indicates the second purpose.

In the example process 4-2, a control unit of the communication apparatus 100-A functions as a provision means that provides use information pertaining to a purpose of connection to the communication apparatus 100-5 and the communication apparatus 100-6, which are communication destination candidates.

Upon receiving the use information from the communication apparatus 100-A, the control unit of the communication apparatus 100-5 and the control unit of the communication apparatus 100-6 transmit, to the communication apparatus 100-A, the following as responses to the use information:
the related information RI 100-5 related to the communication apparatus 100-5; and
the related information RI 100-6 related to the communication apparatus 100-6.
   The control unit of the communication apparatus 100-A also functions as an acquisition means that acquires the related information.

Furthermore, in the example process 4-2, in a case where the use information indicates the second purpose, the control unit of the communication apparatus 100-5 and the control unit of the communication apparatus 100-6 may be configured to provide the communication apparatus 100-A with the related information, which is
the number of established connections in which the communication apparatus 100-5 is involved, and
the number of established connections in which the communication apparatus 100-6 is involved, respectively,
   so that the control unit of the communication apparatus 100-A acquires these pieces of information.

The control unit of the communication apparatus 100-A also functions as a determination means that determines connection/disconnection to/from the communication apparatus 100-2 and connection/disconnection to/from the communication apparatus 100-3 with reference to the following:
the related information RI 100-2 related to the communication apparatus 100-2; and
the related information RI 100-3 related to the communication apparatus 100-3.

For example, the control unit of the communication apparatus 100-A determines, in a case where the purpose of connection is the second purpose, establishment of connection with one of the communication apparatus 100-5 and the communication apparatus 100-6 which one has a larger number of established connections. For example, in the example illustrated in FIG. 21, the control unit of the communication apparatus 100-A judges that a connection in which the communication apparatus 100-5 is involved has more established connections, and establishes a connection C5A with the communication apparatus 100-5 while establishing no connection with the communication apparatus 100-6.

Note that a specific method in which the control unit of the communication apparatus 100-A acquires the above pieces of related information does not limit the third example embodiment. For example, the control unit of the communication apparatus 100-A can be configured to refer to a scanning beam or response beam received from a corresponding one of the communication apparatus 100-5 and the communication apparatus 100-6, which are the communication destination candidates, and acquire related information included in the scanning beam or response beam.

A requirement required for a communication path commonly may vary in accordance with a purpose of the communication path. According to the example process 4-2, the control unit of the communication apparatus 100-A is configured to:
provide, to at least one communication destination, use information pertaining to a purpose of connection;
from the at least one communication destination, acquire, as a response to the use information, related information related to the at least one communication destination; and
determine connection/disconnection to/from the at least one communication destination with reference to the related information related to the at least one communication destination.
   This makes it possible to configure a suitable communication path in accordance with an objective of connection.

In the example process 4-2, the communication apparatus 100-A establishes communication with a communication apparatus with a relatively larger number of established connections among the communication destination candidates. This makes it possible to configure the communication system 1a that is more reliable.

(Example Process 4-3 Carried Out by Communication Apparatus)

Subsequently, an example process 4-3 carried out by a communication apparatus will be described. FIG. 22 is a diagram illustrating the communication system 1a according to the example process 4-3. The example process 4-3 is an example process in a case where a new communication apparatus 100-A is connected to the communication system 1a. Note here that the new communication apparatus 100-A has, for example, a configuration similar to the configuration of the communication apparatus 100.

In the example process 4-3, the communication apparatus 100-A functions as an acquisition means that acquires, from the communication apparatus 100-3 and the communication apparatus 100-5, which are communication destination candidates,
the related information RI 100-3 related to the communication apparatus 100-3, and
the related information RI 100-5 related to the communication apparatus 100-5, respectively.

Note here that the related information RI 100-3 and the related information RI 100-3 include
a hop count from the communication apparatus 100-3 to a connection reference point, and
a hop count from the communication apparatus 100-5 to the connection reference point, respectively.
   Note here that a specific example of the connection reference point does not limit the third example embodiment. For example, the connection reference point refers to a terminal, a communication apparatus, or the like, which is a connection point from a network constituted by the communication system 1a to another network. For example, a reference sign 100-X indicates the connection reference point in FIG. 22.

A control unit of the communication apparatus 100-A functions as a determination means that determines, with reference to hop count information included in the related information RI 100-3 and the related information RI 100-5, connection with a communication destination that has a smaller hop count to the connection reference point.

For example, in the case of the example illustrated in FIG. 22, the hop count from the communication apparatus 100-3 to the connection reference point 100-X is 1, and the hop count from the communication apparatus 100-5 to the connection reference point 100-X is 2 or 3. Thus, the control unit of the communication apparatus 100-A establishes connection with the communication apparatus 100-3, which has a smaller hop count to the connection reference point 100-X, out of the communication apparatus 100-3 and the communication apparatus 100-5, whereas the control unit of the communication apparatus 100-A establishes no connection with the communication apparatus 100-5.

Note that a specific method in which the control unit of the communication apparatus 100-A acquires the above pieces of related information does not limit the third example embodiment. For example, the control unit of the communication apparatus 100-A can be configured to refer to a scanning beam or response beam received from a corresponding one of the communication apparatus 100-3 and the communication apparatus 100-5, which are the communication destination candidates, and acquire related information included in the scanning beam or response beam.

According to the example process 4-3, the communication apparatus 100-A establishes connection with a communication destination candidate that has a smaller hop count to the connection reference point. This makes it possible to configure the communication system 1a in which more suitable connection is achieved.

[Software Implementation Example]

Some or all of the functions of each of the communication apparatuses 10, 10-1 to 10-4, 20, 20-1 to 20-4, 100, 100-1 to 100-9, and 100-A may be realized by hardware such as an integrated circuit (IC chip) or may be alternatively realized by software.

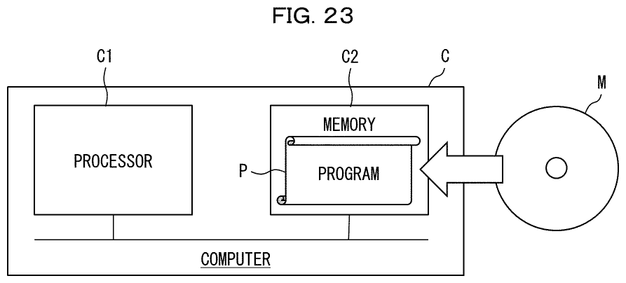

In the latter case, the communication apparatuses 10, 10-1 to 10-4, 20, 20-1 to 20-4, 100, 100-1 to 100-9, and 100-A are each realized by, for example, a computer that executes instructions of a program that is software realizing the functions. FIG. 23 illustrates an example of such a computer (hereinafter referred to as “computer C”). The computer C includes at least one processor C1 and at least one memory C2. The memory C2 stores a program P for causing the computer C to operate as each of the communication apparatuses 10, 10-1 to 10-4, 20, 20-1 to 20-4, 100, 100-1 to 100-9, and 100-A. In the computer C, the functions of each of the communication apparatuses 10, 10-1 to 10-4, 20, 20-1 to 20-4, 100, 100-1 to 100-9, and 100-A are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can also be described as below. Note, however, that the present invention is not limited to the following example aspects.

(Supplementary Note 1)

A communication apparatus including:
at least one communication means that is configured to be capable of transmitting and receiving directional communication media; and
a determination means that determines at least one communication destination with which to communicate by the at least one communication means,
in the case of determination of communication with a plurality of communication destinations, the determination means selecting the plurality of communication destinations so that an angle between the plurality of communication destinations as viewed from the communication apparatus is not less than a predetermined angle.

According to the above configuration, a communication destination is selected so that an angle between a plurality of communication destinations as viewed from a communication apparatus is not less than a predetermined angle. This brings about an effect of making it possible to minimize influence of disturbance on a communication system. Thus, a robust communication network can be achieved while a directional communication medium is used.

(Supplementary Note 2)

The communication apparatus according to Supplementary note 1, wherein the determination means determines the at least one communication destination with reference to positional information of the at least one communication destination with which to communicate by the at least one communication means and which has been obtained by scanning.

According to the above configuration, a robust communication network can be quickly achieved while a directional communication medium is used.

(Supplementary Note 3)

The communication apparatus according to Supplementary note 1 or 2, wherein
the determination means includes a priority determination means that determines priority of the at least one communication destination with which to communicate by the at least one communication means,
in a case where a communication destination candidate is present in a range of predetermined angles from a connected communication destination, the priority determination means lowering priority of the communication destination candidate.

According to the above configuration, a robust communication network can be suitably achieved while a directional communication medium is used.

(Supplementary Note 4)

A communication apparatus including:
at least one communication means that is configured to be capable of transmitting and receiving directional communication media; and
a determination means that determines priority of at least one communication destination with which to communicate by the at least one communication means,
in a case where a communication destination candidate is present in a range of predetermined angles from a connected communication destination, the determination means lowering priority of the communication destination candidate.

The above configuration makes it possible to minimize influence of disturbance on a communication system. Thus, a robust communication network can be achieved while a directional communication medium is used.

(Supplementary Note 5)

A communication apparatus including:
at least one communication means that is configured to be capable of transmitting and receiving directional communication media; and
a determination means that determines at least one communication destination with which to communicate by the at least one communication means,
the determination means determining the at least one communication destination from among at least one communication destination candidate with reference to positional information of the at least one communication destination candidate.

According to the above configuration, the at least one communication destination is determined from among at least one communication destination candidate with reference to positional information of the at least one communication destination candidate. This brings about an effect of making it possible to configure a robust communication system including a communication apparatus that is suitably disposed.

(Supplementary Note 6)

The communication apparatus according to Supplementary note 5, wherein
from among the at least one communication destination candidate, the determination means determines, as the at least one communication destination, at least one communication destination candidate whose distance from the communication apparatus is in a predetermined range.

The above configuration brings about an effect of making it possible to configure a robust communication system including a communication apparatus that is suitably disposed.

(Supplementary Note 7)

The communication apparatus according to Supplementary note 5 or 6, wherein
the determination means determines the at least one communication destination with reference to positional information obtained from a scanning signal that the at least one communication means has received prior to establishment of connection with the at least one communication destination.

According to the above configuration, a robust communication network can be quickly achieved while a directional communication medium is used.

(Supplementary Note 8)

A communication system including a plurality of communication apparatuses, wherein
at least any two or more of the plurality of communication apparatuses each include:
   at least one communication means that is configured to be capable of transmitting and receiving directional communication media; and
   a determination means that determines at least one communication destination with which to communicate by the at least one communication means,
   in the case of determination of communication with a plurality of communication destinations, the determination means selecting the plurality of communication destinations so that an angle between the plurality of communication destinations as viewed from a corresponding communication apparatus is not less than a predetermined angle.

According to the above configuration, a communication destination is selected so that an angle between a plurality of communication destinations as viewed from a communication apparatus included in a communication system is not less than a predetermined angle. This brings about an effect of making it possible to minimize influence of disturbance on the communication system. Thus, a robust communication network can be achieved while a directional communication medium is used.

(Supplementary Note 9)

A communication system including a plurality of communication apparatuses, wherein
at least any two or more of the plurality of communication apparatuses each include:
   at least one communication means that is configured to be capable of transmitting and receiving directional communication media; and
   a determination means that determines priority of at least one communication destination with which to communicate by the at least one communication means,
   in a case where a communication destination candidate is present in a range of predetermined angles from a connected communication destination, the determination means lowering priority of the communication destination candidate.

The above configuration makes it possible to minimize influence of disturbance on a communication system. Thus, a robust communication network can be achieved while a directional communication medium is used.

(Supplementary Note 10)

A communication system including a plurality of communication apparatuses, wherein
at least any two or more of the plurality of communication apparatuses each include:
   at least one communication means that is configured to be capable of transmitting and receiving directional communication media; and
   a determination means that determines at least one communication destination with which to communicate by the at least one communication means,
   the determination means determining the at least one communication destination from among at least one communication destination candidate with reference to positional information of the at least one communication destination candidate.

According to the above configuration, the at least one communication destination is determined from among at least one communication destination candidate with reference to positional information of the at least one communication destination candidate. This brings about an effect of making it possible to configure a robust communication system including a communication apparatus that is suitably disposed.

(Supplementary Note 11)

A communication method including determining at least one communication destination of a communication apparatus including at least one communication means that is configured to be capable of transmitting and receiving directional communication media, wherein
in the determining,
   in the case of determination of communication with a plurality of communication destinations, the plurality of communication destinations are selected so that an angle between the plurality of communication destinations as viewed from the communication apparatus is not less than a predetermined angle.

According to the above configuration, a communication destination is selected so that an angle between a plurality of communication destinations as viewed from a communication apparatus is not less than a predetermined angle. This brings about an effect of making it possible to minimize influence of disturbance on a communication system. Thus, a robust communication network can be achieved while a directional communication medium is used.

(Supplementary Note 12)

A communication method including determining priority of at least one communication destination of a communication apparatus including at least one communication means that is configured to be capable of transmitting and receiving directional communication media, wherein
in the determining,
   in a case where a communication destination candidate is present in a range of predetermined angles from a connected communication destination, priority of the communication destination candidate is lowered.

The above configuration makes it possible to minimize influence of disturbance on a communication system. Thus, a robust communication network can be achieved while a directional communication medium is used.

(Supplementary Note 13)

A communication method including determining at least one communication destination of a communication apparatus including at least one communication means that is configured to be capable of transmitting and receiving directional communication media, wherein
in the determining,
   the at least one communication destination is determined from among at least one communication destination candidate with reference to positional information of the at least one communication destination candidate.

According to the above configuration, the at least one communication destination is determined from among at least one communication destination candidate with reference to positional information of the at least one communication destination candidate. This brings about an effect of making it possible to configure a robust communication system including a communication apparatus that is suitably disposed.

(Supplementary Note 14)

A communication program for causing a computer to operate as the communication apparatus according to any one of Supplementary notes 1 to 7, the communication program causing the computer to function as each of the foregoing means.

(Supplementary Note 15)

A communication apparatus including at least one processor,
the at least one processor carrying out a determination process for determining at least one communication destination with which to communicate by at least one communication means that is configured to be capable of transmitting and receiving directional communication media, wherein
in the determination process,
   in the case of determination of communication with a plurality of communication destinations, the plurality of communication destinations are selected so that an angle between the plurality of communication destinations as viewed from a corresponding communication apparatus is not less than a predetermined angle.

(Supplementary Note 16)

A communication apparatus including at least one processor,
the at least one processor carrying out a determination process for determining priority of at least one communication destination with which to communicate by a communication means that transmits and receives directional communication media, wherein
in the determination process,
   in a case where a communication destination candidate is present in a range of predetermined angles from a connected communication destination, priority of the communication destination candidate is lowered.

(Supplementary Note 17)

A communication apparatus including at least one processor,
the at least one processor carrying out a determination process for determining priority of at least one communication destination with which to communicate by a communication means that transmits and receives directional communication media, wherein
in the determination process,
   the at least one communication destination is determined from among at least one communication destination candidate with reference to positional information of the at least one communication destination candidate.

Note that the communication apparatus may further include a memory, which may store a program for causing the processor to carry out each of the foregoing processes. The program may be stored in a computer-readable non-transitory tangible storage medium.

[Additional Remark 3]

This application claims priority on Patent Application No. 2021-061070 filed in Japan on Mar. 31, 2021, the entire contents of which are hereby incorporated by reference.

### REFERENCE SIGNS LIST

1, 1a Communication system
10, 10-1-10-4, 20, 20-1-20-4 Communication apparatus
11, 21 Communication unit (communication means)
12 Specification unit
13 Connection establishment unit
22 Determination unit (determination means)
100, 100-1-100-9, 100-A Communication apparatus
130 Control unit
131 Acquisition unit
132 Communication management unit (determination means)
133 Storage management unit
150 Storage unit
110-1, 110-2 First communication unit (communication means)
120 Second communication unit

What is claimed is:

1. A communication apparatus comprising:
at least one communication unit that is configured to be capable of transmitting and receiving directional communication media; and
at least one processor,
the at least one processor carrying out:
a determination process for determining at least one communication destination with which to communicate by the at least one communication unit,
in the determination process, in the case of determination of communication with a plurality of communication destinations, the at least one processor selecting the plurality of communication destinations so that an angle between the plurality of communication destinations as viewed from the communication apparatus is not less than a predetermined angle.

2. The communication apparatus according to claim 1, wherein in the determination process, the at least one processor determines the at least one communication destination with reference to positional information of the at least one communication destination with which to communicate by the at least one communication unit and which has been obtained by scanning.

3. The communication apparatus according to claim 1, wherein
in the determination process, the at least one processor carries out a priority determination process for determining priority of the at least one communication destination with which to communicate by the at least one communication unit, and
in the priority determination process, in a case where a communication destination candidate is present in a range of predetermined angles from a connected communication destination, the at least one processor lowers priority of the communication destination candidate.

4. (canceled)

5. (canceled)

6. The communication apparatus according to claim 1, wherein
in the determination process, from among the at least one communication destination candidate, the at least one processor determines, as the at least one communication destination, at least one communication destination candidate whose distance from the communication apparatus is in a predetermined range.

7. (canceled)

8. A communication system comprising a plurality of communication apparatuses, wherein
at least any two or more of the plurality of communication apparatuses each include:
at least one communication unit that is configured to be capable of transmitting and receiving directional communication media; and
at least one processor,
the at least one processor carrying out:
a determination process for determining at least one communication destination with which to communicate by the at least one communication unit,
in the determination process, in the case of determination of communication with a plurality of communication destinations, the at least one processor selecting the plurality of communication destinations so that an angle between the plurality of communication destinations as viewed from a corresponding communication apparatus is not less than a predetermined angle.

9. The communication system according to claim 8, wherein
in the determination process, in a case where a communication destination candidate is present in a range of predetermined angles from a connected communication destination, the at least one processor lowers priority of the communication destination candidate.

10. The communication system according to claim 8, wherein
in the determination process, the at least one processor determines the at least one communication destination from among at least one communication destination candidate with reference to positional information of the at least one communication destination candidate.

11. A communication method comprising determining at least one communication destination of a communication apparatus including at least one communication unit that is configured to be capable of transmitting and receiving directional communication media, wherein
in the determining,
in the case of determination of communication with a plurality of communication destinations, the plurality of communication destinations are selected so that an angle between the plurality of communication destinations as viewed from the communication apparatus is not less than a predetermined angle.

12. The communication method according to claim 11, wherein
in the determining,
in a case where a communication destination candidate is present in a range of predetermined angles from a connected communication destination, priority of the communication destination candidate is lowered.

13. A communication method according to claim 11, wherein
in the determining,
the at least one communication destination is determined from among at least one communication destination candidate with reference to positional information of the at least one communication destination candidate.
